(19) United States
(12) Patent Application Publication
(10) Pub. No.: US 2026/0189532 A1
(43) Pub. Date: Jul. 2, 2026

(54) SECURITY MECHANISMS FOR LEDGER SYSTEMS FOR DIGITAL CURRENCIES

(71) Applicant: NATIONAL CURRENCY TECHNOLOGIES, INC, ASHBURN, VA (US)

(72) Inventors: Joshua Mitchell Povsner, Ashburn, VA (US); Brandon Sommerfeld, Naperville, IL (US); Sara Inoue, Anchorage, AK (US)

(21) Appl. No.: 19/437,530

(22) Filed: Dec. 31, 2025

Related U.S. Application Data
(60) Provisional application No. 63/740,973, filed on Dec. 31, 2024.
(60) Provisional application No. 63/780,850, filed on Mar. 31, 2025.

(51) Int. Cl. H04L 9/40

(52) U.S. Cl. CPC H04L 63/02

(57) ABSTRACT

A security system for a digital asset ledger includes at least one of a security gateway or a ledger storage system. The security gateway executes a plurality of algorithms in parallel to process packets. Each algorithm processes packets by implementing a plurality of safety checks by checking data in fields at predetermined relative locations of the payloads of the packets. The ledger storage system stores records of current ownership of instances of a tracked digital asset without storing historical records of ownership of the instances of the tracked digital asset, and performs ownership checks by confirming whether ownership listed in each packet is correct for at least one instance of the tracked digital asset listed in the packet.

### CROSS REFERENCE TO RELATED APPLICATIONS

This patent application claims priority to U.S. provisional application No. 63/740,973, filed Dec. 31, 2024, and to U.S. provisional application No. 63/780,850, filed Mar. 31, 2025, which are each hereby incorporated by reference in their entireties.

### GOVERNMENT INTEREST

This invention was made with government support under Award Number 2208351 awarded by the United States National Science Foundation. The United States government has certain rights in the invention(s) described herein.

Specifically, one or more aspects of invention(s) described in U.S. provisional application No. 63/740,973 are attributable to research performed under Award Number 2208351, and the United States government has certain rights in the invention(s) attributable to that research.

### BACKGROUND

National digital currencies (NDCs) are potentially useful to supplement or replace national physical currencies. NDCs have gained attention in recent years as governments explore ways to modernize their financial systems, enhance economic efficiency, and address crimes enabled by national physical currencies and private digital currencies. In patent applications previously filed starting in 2021, National Currency Technologies, Inc. (NCT) described a central system (CS) for an NDC. Several key aspects of the CS include the use of a security gateway system (SGS) and a requirement for short, formatted inquiries or instructions (SFIOIs) as the mechanism for the public to communicate with the SGS. SFIOIs are communications from parties for making inquiries to the CS or for providing instructions to the CS. The requirement for SFIOIs to be in a uniform format for communications to the CS from the public helps ensure safety whereas keeping the uniform format as simple as possible helps ensure maximum inclusivity and familiarity to the public.

FIG. 1 shows a now-conventional CS 150 submitted in the proposal that resulted in Award Number 2208351. In the CS 150, SFIOIs were carried to the SGS 156 over the ECN 130 (electronic communications network) which is representative of the internet. The CS 150 also includes an IDMS 151 (identification management system), a LSS 152 (ledger storage system), an MMS 153 (main memory system), an AIAS 154 (artificial intelligence and analytics system) and a BUMS 155 (backup memory system). The LSS 152 is a real-time ownership ledger that stores current ownership for SFIOIs.

The software to be developed for the SGS 156 under Award Number 2208351 was intended to be multiple sub-applications that could be coordinated and sequentially applied to each SFIOI by different cores of a multi-core processor. SFIOIs were to be held at the SGS 156 while being subject to the security checks at the SGS 156 and also while ownership checks for the SFIOIs were performed at the LSS 152. Responses to ownership inquiries at the LSS 152 were to be returned from the LSS 152 to the SGS 156 while the SFIOI was held at the SGS 156. The SFIOI format was earlier 512 bytes, so 64 64-bit Words, with half (i.e., 256 bytes or 32 Words) reserved for tracking of statuses as the sub-applications were coordinated and sequentially applied to each SFIOI. Fields from and including Word 25 to Word 32 were intended to be reserved for later adaptation. Fields from and including Word 33 to Word 64 were intended for use for the coordinating and tracking of statuses of completed tasks by the sub-applications in a manner that did not result in writing too many times to one specific memory location as this would be the likely driver for the memory expiring from use over time. The memory where SFIOIs were to be stored in the SGS 156 while being processed was originally mostly suggested to be flash memory.

During research and development under Award Number 2208351, NCT identified several problems and several solutions to such problems as improvements to operations of the SGS 156. Problems included 1.) an unresolvable risk of conflicts in memory access imposed by coordinating multiple cores to sequentially apply multiple sub-applications to perform security checks on an individual SFIOI, 2.) unnecessary operational complexity imposed by holding SFIOIs at the SGS 156 while ownership checks were performed at the LSS 152 and then coordinating responses at the SGS 156, and 3.) inefficient and excessive space allocated in the 512-byte SFIOI such as for status tracking. All of those problems and more were solved during the research and development under Award Number 2208351.

An NDC ledger system must therefore be robust enough to withstand cyber-attacks, prevent fraudulent activities including double-spending, prevent unauthorized access, and protect sensitive financial information. The NDC ledger system must be accessible to a wide range of users while ensuring security. The NDC ledger system must be user-friendly and easily accessible to individuals with varying levels of technological expertise. Striking a balance between accessibility and security is crucial, as increased accessibility may potentially introduce vulnerabilities. Therefore, there is a continued need to overcome the many issues faced in developing an NDC ledger system. Solving these issues for an NDC ledger system should provide technologies usable for other types of digital assets including any NDC, as well as cryptocurrencies, stablecoins, tokens and other digital assets and digital representations of real-world assets.

### SUMMARY

An objective of the teachings herein is a secure NDC ledger system that is accessible to the worldwide population and that is capable of operating in near real-time at enormous volumes. The described embodiments, together with further advantages, will be best understood by reference to the following detailed description taken in conjunction with the accompanying drawings.

### BRIEF DESCRIPTION OF THE DRAWINGS

Example embodiments are best understood from the following detailed description when read in context with the accompanying drawing figures, in which:

FIG. 1 illustrates a CS described in previous patent applications filed by NCT and the proposal that resulted in Award Number 2208351 awarded by the National Science Foundation.

FIG. 2A illustrates an LS (ledger system) for tracking NDCs; FIG. 2B illustrates a partial communications flow for the LS for tracking NDCs in FIG. 2A.

FIG. 3A illustrates an example format for a SFIOI. FIG. 3B illustrates an alternative view of the current example SFIOI format.

FIG. 4A illustrates a module configuration for an SGS; FIG. 4B illustrates a method of processing SFIOIs at an SGS.

FIG. 5A illustrates a method for processing PACKETs at an LSS; FIG. 5B illustrates a party ID field at an LSS; FIG. 5C illustrates example virtue note (VN) placements in an example format for a PACKET; FIG. 5D illustrates an example layout for space dedicated to a party at an LSS; FIG. 5E illustrates an example occupied/unoccupied field at an LSS; FIG. 5F illustrates a change field at an LSS; FIG. 5G illustrates a circuit arrangement for an LSS; FIG. 5H illustrates a party ID field in the SFIOI format as compared to at the LSS.

FIG. 6 illustrates a computer system, on which a method for implementation mechanisms for digital currencies is implemented, in accordance with another representative embodiment.

FIG. 7 illustrates a distribution of paired SGSs and LSSs for a CS.

### DETAILED DESCRIPTION

In the following detailed description, for purposes of explanation and not limitation, representative embodiments disclosing specific details are set forth in order to provide a thorough understanding of the representative embodiments according to the present teachings. However, other embodiments consistent with the present disclosure may depart from specific details disclosed herein. Descriptions of known systems, devices, methods of operation and methods of manufacture may be omitted so as to avoid obscuring the description of the representative embodiments. Nonetheless, systems, devices and methods that are within the purview of one of ordinary skill in one or more of the numerous arts relevant to the present teachings are within the scope of the present teachings and may be used in accordance with the representative embodiments. It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

Aspects of the teachings herein are best understood by reference to the description set forth herein. All the aspects described herein will be better appreciated and understood when considered in conjunction with the following descriptions. It should be understood, however, that the following descriptions, while indicating preferred aspects and numerous specific details thereof, are given by way of illustration only and should not be treated as limitations. Changes and modifications may be made within the scope herein without departing from the spirit and scope thereof, and the teachings herein includes all such modifications.

In the descriptions herein, a ledger system for an NDC is used as the basis of explanations for tracking a digital asset represented herein by NDCs. An NDC ledger system described herein serves as the NDC infrastructure. The NDC ledger system will be responsible for recording and verifying all transactions, and maintaining the integrity of the NDC.

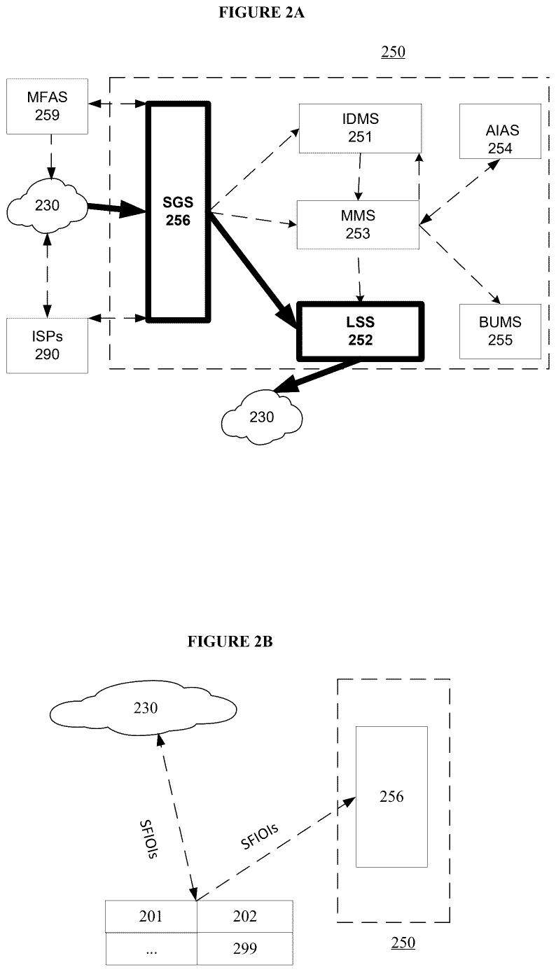

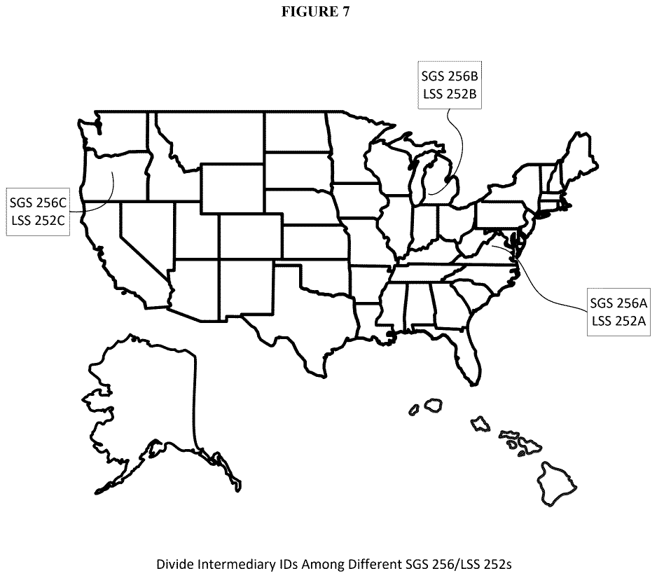

FIG. 2A illustrates a ledger system (LS) for tracking NDCs. The LS 250 in FIG. 2A is centralized in that an ownership record for any particular VN is controlled by one place at any particular time. A real-time ownership record for a VN may be moved within an LSS 252 or between different instances of the LSS 252, such as when ownership is transferred between parties. Different instances of the LSS 252 are shown in and explained with respect to FIG. 7, such as when an NDC is regionalized such that different intermediaries and their customers can be assigned to different instances of the LSS 252. In any instance of an LS, one or more backup may be provided for each element, such as in the event of power failure or communication failure.

In the LS 250 for tracking NDCs illustrated in FIG. 2A, the SGS 256 is used as the interface between the worldwide public and other elements of the LS 250 in terms of processing SFIOIs. While the SGS 256 may theoretically be implemented using a commercial computer such as a desktop computer or laptop computer as long as the commercial computer has memory such as DDR4 or DDR5 or other byte-addressable memory and a processor such as a multi-core with eight (8) or sixteen (16) individual processing cores, NCT is in the process of building prototype security gateways as minimized application-specific integrated circuits (ASICs). The minimized ASICs are intended to have defensible characteristics, including one or more of: 1.) no requirements for updates to operating systems, 2.) dedicated to the uses described herein and not any other uses, 3.) no emissions of wireless signals, 4.) a hardened shell that prevents electromagnetic interference, and 5.) limited input and output ports for the purposes described herein.

DRAM/SDRAM may be used for the memory units of the SGS 256, so that SFIOIs may be stored in physical and/or virtual rows. For example, SFIOIs formatted in the current 128-byte format may be stored in physical and/or virtual order in 2048-byte rows or 4096-byte rows of a SDRAM structure. The SFIOIs may be stored, for example, one per row, two per row, four per row, eight (8) per row, sixteen per row, thirty two per row etc. in the same relative locations of each row relative to the start of each row, so that the processing by the threads run by the cores of the multicore processor may consistently reference the proper relative locations of the stored SFIOIs in each row, and then proceed to the next row once processing for the SFIOIs in the current row is complete. The sizes of various data used for specifying information for NDCs in the SFIOI format may be relatively small. 32 bits (4 bytes) is more than enough to uniquely identify the current U.S. population with unique identifications for NDCs. Eight (8) bits (1 byte) is more than enough to uniquely identify each individual nation in the world with a unique identification for NDCs. Sixteen (16) bits (2 bytes) is more than enough to uniquely identify each bank or similar entity in the U.S. with a unique identification for NDCs.

At some times in some embodiments where the SGS 256 is not overly-busy, SFIOIs may be pulled directly from a network card in the SGS 256 to registers (e.g., 16 registers) of a core of a multi-core processing the SFIOIs in the SGS 256 without being stored in the DRAM/SDRAM. SFIOIs may at least theoretically be processed according to the processing described herein in real-time without being particularly stored in DRAM/SDRAM, though storage in registers dedicated to a core should still be considered storage in a memory of the SGS 256.

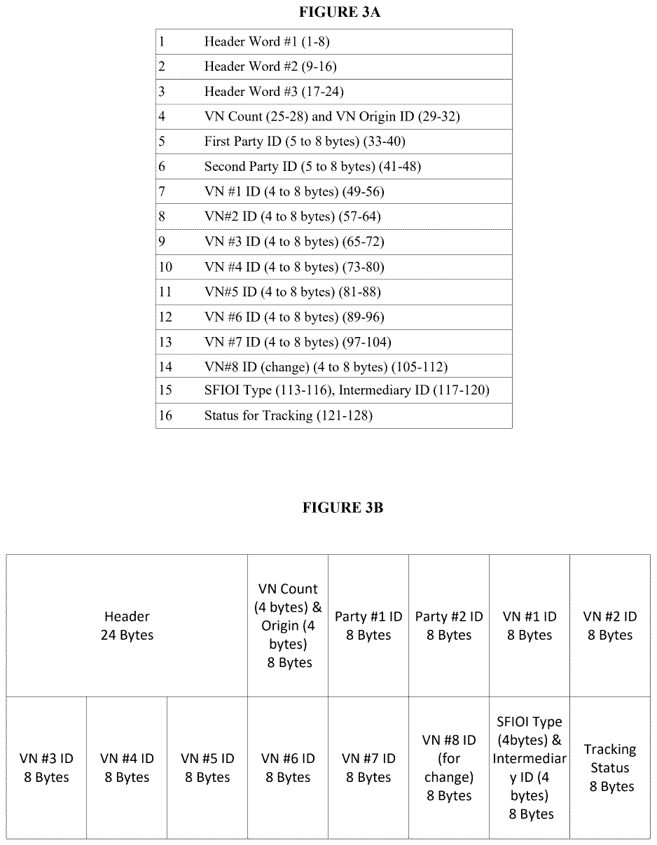

The public that interfaces with the SGS 256 may be any person anywhere in the world insofar as the SGS 256 does not necessarily perform decryption, handshaking, or other forms of conventional network security measures. The SGS 256 is configured to inspect SFIOIs and mark unacceptable SFIOIs when any security check is failed. Requiring conformity with the SFIOI format and processing only fields at predetermined relative locations of payloads in the manner described herein to perform safety checks is the only way SFIOIs can proceed to have inquiries or instructions to the LS 250 processed. An example SFIOI format is shown in and described with respect to FIG. 3A. Initially, the LS 250 may only accept SFIOIs via intermediaries, but downstream the intent is to accept SFIOIs directly from the public without requiring any particular intermediary. Downstream, an instance of the SGS 256 may be specifically dedicated to only accepting SFIOIs directly from the public without any intermediary, but additional security measures such as multi-factor authentication will be required for these parties in the absence of supervised intermediaries.

The system architecture in FIG. 2A includes an ECN 230 and an LS 250. The ECN 230 facilitates communication between the various components of the LS 250 and with the public. The ECN 230 ensures that data is effectively and efficiently transmitted throughout the LS 250 and, for example between the public and the SGS 256 and between the LSS 252 and the public, enabling the various components to work together. The ECN 230 may comprise a wide area network such as the internet. Connections between elements of the LS 250 may be by hardwire or by persistent virtual private networks (VPNs). For example, elements of the LS 250 that are connected remotely may be connected by a unique VPN that is always-on, and the encryption of any particular VPN may be regularly updated such as hourly, daily, weekly or on an ad-hoc basis. Communications within the LS 250 may also or alternatively use internal addressing so that an outside party is prevented from being aware of how elements communicate.

The LS 250 includes the SGS 256, an IDMS 251 (identification management system), a LSS 252 (ledger storage system), a MMS 253, an AIAS 254, a BUMS 255 (backup memory system). The LS 250 also includes or accommodates an MFAS 259 (Multi-Factor Authentication System), and ISPs 290 (Intermediary Service Providers).

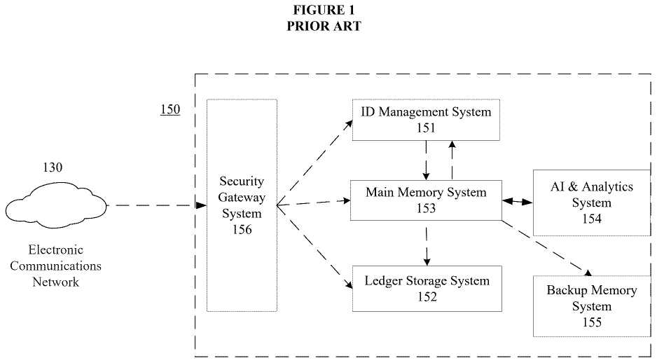

The SGS 256 receives SFIOIs as packetized communications that are supposed to be in a required packet format via the ECN 230 which is representative of the internet. The packets are required to comply with the uniform format for SFIOIs, though the required SFIOI format has been and may still be updated. SFIOIs described herein for the SGS 256 in FIG. 2A do not necessarily have to comply specifically with an internet protocol (IP) format such as IPv4 or IPv6, such as when the packets are received via an intermediary system described herein such that the packets do not necessarily require some or any of the header information of an IP format. The SGS 256 includes a memory that stores a plurality of algorithms and a multi-core processor with a plurality of cores that respectively execute the plurality of algorithms in parallel to process SFIOIs received over the internet. The use of a singular algorithm implemented by a single thread executed by a single core is an improvement in several ways relative to using different algorithms implemented by different threads executed by different cores. The use of the singular algorithm to process a SFIOI avoids the potential for memory access conflicts by different threads, requires much less space for tracking in the SFIOI format, and is much faster and less complex. The memory may include byte addressable memory used to store SFIOIs received from the public when they are not directly processed upon receipt, as well as sets of registers dedicated to corresponding cores and used for operations when processing the SFIOIs. Byte addressable memory includes DDR4 and DDR5 memories which are arranged in bank groups, banks of bank groups, and rows and columns of banks. Reading from and writing to byte addressable memory may involve a memory controller referencing specific bytes, or fields with groups of adjacent bytes, in a SFIOI stored in the byte addressable memory, such as by retrieving data by columns from the byte addressable memory into the registers dedicated to a core for processing. The memory that stores the plurality of algorithms may be the same as or different from the addressable memory used to store SFIOIs received over the internet. For the LS 250 described herein, each individual algorithm executed by each core of a multicore processor at the SGS 256 may process the entirety of a SFIOI. For example, a single core that executes a single algorithm may execute one or more security checks on each SFIOI and then send some or all of the SFIOI to the LSS 252 for the ownership check. Cores of a multicore may be assigned different portions of a memory, such as different banks of a memory bank group, different portions of one bank, groups of rows of a bank such as rows 1-16, 17-32, 33-48, or alternating rows of a bank such as having one core process rows 1, 17, 33, 49 etc.

Whereas the original thinking for the now-conventional CS 150 was that SGS 156 would serve as both the entry for SFIOIs and the exit for responses in the CS 150 from the public in FIG. 1, in FIG. 2A the SGS 256 serves as the entry for SFIOIs and the LSS 252 serves as the exit for responses. This is partly because secondary safety checks are implemented by the LSS 252, including the ownership checks described herein, and exiting SFIOIs from the LSS 252 avoids requiring coordination of responses from the LSS 252 at the SGS 256 and updating of statuses at the SGS 256 after ownership checks are performed at the LSS 252. In other words, exiting SFIOIs from LSS 252 is partly because its logically more efficient and simpler to provide responses to the public from the LSS 252 than to track the processing for the SFIOIs entirely at the SGS 256 including for responses from the LSS 252. The overall processing is greatly simplified by having the LSS 252 provide the exits from the LS 250 back to the public. The SGS 256 inspects packets for compliance with a required format before the packets are sent to the LSS 252. The SGS 256 serves as the first line of defense against potential security threats, ensuring that packets pass initial security checks for compliance with the required format. This helps ensure that only valid and properly formatted data enters the LS 250, minimizing the risk of errors or malicious activity.

The IDMS 251 may be used to store and update records for parties authorized to use the NDC tracked by the LS 250. The IDMS 251 is responsible for managing the identification of parties involved in the transactions. The IDMS 1251 maintains party identifications assigned to each party or user authorized to use VNs in the LS 250. The IDMS 251 ensures that each party is properly identified and authenticatable before they can participate in any transaction. The IDMS 251 keeps track of unique identifiers assigned to each party, and the unique identifiers are then used to reference the parties in the LSS 252, MMS 253 and BUMS 255.

The LSS 252 is a ledger storage system that stores records of current ownership of instances of a tracked digital asset represented by the VNs of an NDC. The LSS 252 may be used to confirm ownership as part of security checks at the LS 250. The LSS 252 may confirm ownership of instances of each of the VNs listed in SFIOIs for all proper instances, insofar as confirming that the sender of a SFIOI has accurate knowledge of ownership of all VNs listed in the SFIOI may be an important safety check for the SFIOI. The LSS 252 performs ownership checks by confirming whether ownership listed in each SFIOI that passed processing by the plurality of algorithms at the SGS 256 is correct for at least one instance of the tracked digital asset in the SFIOI. The LSS 252 is also configured to initiate disposition of SFIOIs according to the SFIOI Type field as a (second) specified field at a second predetermined relative location of the payloads of SFIOIs that pass all of the safety checks at the SGS 256 and the ownership checks at the LSS 252. The initiated disposition may be one of a plurality of possible dispositions specified by a value in the SFIOI Type field in the (second) specified field at the (second) predetermined relative location. As explained with respect to, e.g., FIG. 7, the LSS 252 may be paired with the SGS 256 as a security system, and multiple pairs of LSSs and SGSs may be provided and disposed around a nation. Distribution of such pairs as a ledger may serve as a form of ledger that is distributed but which is not a distributed ledger in that these pairs of SGSs and LSSs are not a consensus mechanism. The LSS 252 includes dedicated physical memory space for each party using an intermediary assigned to the LSS 252. SFIOIs are packets that with appropriate headers may be carried over the internet, and otherwise may be provided by intermediaries without necessarily requiring appropriate headers. The terms SFIOI and packet may be used interchangeably herein, though SFIOIs refer to packets that comply or are supposed to comply with a required SFIOI format. The LSS 252 performs ownership checks for VNs listed in packets received at the LSS 252 according to purported owners listed in the packets and assigned party identifications by the intermediaries assigned to the LSS. In the earlier application families, the SGS 256 was thought to be the source of responses to packets, so that responses to ownership checks from LSS 252 must be processed by SGS 256. In this application family, the thinking has been updated so that responses to packets are provided from LSS 252 directly to users or indirectly via intermediaries to users, so there are no responses from LSS 252 to SGS 256. This improvement avoids enormous complexity tracking packets at the SGS 256 while waiting for responses from the LSS 252. As explained herein, the LSS 252 may be used for blacklist and greylist checks and other functionality, so that exits from the LS 250 are from the LSS 252, no coordination is needed at the SGS 256 waiting for responses from the LSS 252, and the LS 250 does not require separate blacklist and/or greylist elements to separately perform blacklist and/or greylist checks. To be sure, pairs of the SGS 256 and the LSS 252 are scalable and duplicable so that the pairs may vary in storage and processing capacity and be spread around a nation. The SGS 256, LSS 252 and other elements may minimize virtualization by directly processing data in packets stored in memory at predetermined relative locations specified in the SFIOI format, even if the SFIOI format is updated more from that shown in FIG. 3A.

As an example for a disposition type, the LSS 252 is configured to proactively confirm ownership of the instances of the tracked digital asset listed in the acceptable SFIOIs without transferring ownership of the instances of the tracked digital asset listed in the acceptable packets as a disposition among a plurality of possible dispositions according to a value in the SFIOI Type field at the (second) predetermined relative location. Other dispositions may include a transfer instructions, a lock my VNs instruction type, an unlock my VNs instruction type, a tell me now which VNS I have inquiry type, and more. The LSS 252 may perform the proactive ownership checks for all SFIOIs that have passed initial processing at the SGS 256, as these proactive ownership checks are a form of secondary security measure. Thus, when the SFIOI type field is checked and indicates that the SFIOI is for an ownership check, the ownership check has already been completed at the LSS 252 as part of the processing for all SFIOIs that have passed initial processing at the SGS 256.

As context for some of the teachings herein, it should be understood that the baseline thinking represented in this disclosure and related disclosures from National Currency Technologies, Inc. is for how NDCs may be implemented for the United States and other nations and regions. One aspect that should be clear is that nations may necessarily not be able to trust any incoming communications to a LS 250, whether directly from individual members of the public, whether indirectly via intermediary service providers (ISPs) like financial institutions or technical companies, or whether indirectly from other governments. From the viewpoint of governments, the assumption should necessarily be that any incoming communications may be malicious, so incoming communications may be limited to the format for SFIOIs and may be subject to uniform safety processing at the SGS 256, regardless of origin.

In the LS 250 in FIG. 2A, elements such as the MMS 253, the LSS 252, the AIAS 254 and the BUMS 255 may not be accessible to the public via an IP address. For example, encryption or even post-quantum encryption may be used so that only communications between elements of the LS 250 will be accepted by other elements of the LS 250. Thus, the SGS 256 may shield the other elements of the LS 250 by being the only way for the public to access the LS 250 to process SFIOIs so that communications from the public to the LS 250 for SFIOIs may be restricted to the SGS 256. Shielding in this sense may involve dedicated lines, encryption specific to any two nodes in the LS 250, use of permanent or semi-permanent VPNs between any two nodes in the LS 250, extensive filtering at each node of the LS 250, and more. Nodes other than the SGS 256 may thus be made directly inaccessible to the public, and at least in the beginning, even the SGS 256 may only accept communications from pre-authorized intermediaries such as banks and fintechs that enable access to their customers. In some embodiments, instances of the LSS 252 and SGS 256 may be collocated or closely-located, with multiple pairs of such instances distributed around a nation as shown in and explained with respect to FIG. 7, though communications with other nodes of the LS 250 will still involve the shielding described above. Communications between any instance of the SGS 256 and any instance of other elements in the LS 250 may be provided via one-way communication links, over a private communications network with dedicated private communication lines and/or via semi-permanent or permanent encrypted communication links using the public internet, such as via virtual private network (VPN) or similar connections.

Numerous additional safety mechanisms for a CS/LS are taught in the previous set of patent filings by National Currency Technologies, Inc., the PCT International patent applications of which were published in August 2022. Such additional safety mechanisms include:
the SGS 256 may include hardware and software that performs comprehensive safety checks to quickly and efficiently process enormous volumes of proper SFIOIs and detects and deletes anything else;
the processing environment of a SGS 256 may logically and temporarily store voluminous pre-filtered SFIOIs in memory units of uniform sizes such as 128 bytes on a 1-to-1 basis 24/7/365;
connection requests may be blocked at network routers in the internet before they reach the LS 250;
the SGS 256 may only receive and accept packetized communications of individual, non-sequential SFIOIs, such as UDP/IP packets and unsequenced TCP/IP packets, and may not accept or establish any incoming connections such as from TCP/IP packet sequences, so as to help thwart DOS attacks;
the required SFIOI format may set a maximum number (e.g., eight (8) or seven (7)) of VNs which can be specified in any single SFIOI.

The MMS 253 stores historical ownership information of the VNs. As a main memory, the MMS 253 may be configured to employ a dual-record approach to store historical ownership information of the VNs by VN and by party, so two forms of records for ownership histories. The MMS 253 maintains a record of past transactions such as for the past 1, 5 or 7 years, providing a history of the ownership of each VN. This information can be useful for providing a comprehensive audit trail, for resolving disputes over ownership, and for supporting various analytical capabilities and regulatory requirement capabilities. Both the MMS 253 and BUMS 255 may be configured to store historical records for the VNs and parties using the VNs. Redundancy further strengthens the LS 250's ability to maintain accurate ownership information. The MMS 253 includes one or more memory systems of random-access memory (RAM) such as DRAMs/SDRAMs, HDDs, and/or other forms of memory appropriate for storing data items. The MMS 253 may store historical records of all instances of a tracked digital asset represented by VNs for a digital asset ledger represented by the LS 250, as well as for party identifications and potentially other forms of information. The MMS 253 is physically remote from the SGS 256 and LSS 252. The MMS 253 is also shielded from the public by the SGS 256 and LSS 252 by being inaccessible to the public over the internet at any internet protocol address. For example, the MMS 253 may be permanently connected to the SGS 256 and/or the LSS 252 via a dedicated and encrypted virtual private network (VPN), or by a dedicated physical link, and otherwise refuse any packets, connection attempts, or other communications from any sources external to the LS 250. The MMS 253 receives updated to the historical records once acceptable packets (SFIOIs) pass processing by the plurality of algorithms at the SGS 256 and ownership checks by the LSS 252. Ownership of VNs by VN identifications may be updated in an append-only memory to add each new owner as the VN changes hands. Ownership of VNs by party identifications may be updated to show when VNs are added to a new party and when they are transferred away from the party.

The AIAS 254 applies artificial intelligence and analytics to the data items in the MMS 253. The AIAS 254 may be similarly physically remote from, shielded from the public by the SGS 256 and LSS 252. The AIAS 254 performs complex analyses on the data stored in the MMS 253 and/or the BUMS 255. The AIAS 254 uses advanced algorithms and machine learning techniques to detect patterns, identify or predict trends in the data,, or identify potential issues or anomalies in the transaction data, providing insights that can help improve the efficiency and security of the LS 250.

The BUMS 255 stores a backup of the records at the MMS 253. More than one instance of the BUMS 255 may be provided for the MMS 253 and one or more backup systems (not shown) may be provided for the LSS 252. The BUMS 255 may be similarly physically remote from, shielded from the public by the SGS 256 and LSS 252. The BUMS 255 serves as a backup for the MMS 253. The BUMS 255 stores a copy of the data in the MMS 253, ensuring that no data is lost in the event of a system failure or other unforeseen circumstances at the MMS 253.

In FIG. 2A, the ISPs 290 may be allowed to interface with the SGS 256 for a variety of reasons including communication security and efficiency. For example, ISPs 290 with large customer bases may provide assurances to customers that communications with the LS 250 will be provided directly from the ISPs 290 to the LS 250 via the SGS 256. For example, the ISPs 290 may be co-located with the SGS 256, or may be closely located to the SGS 256. The ISPs 290 may be physically hardwired into the SGS 256, or may be physically and/or logically linked via a virtual private network to the SGS 256. The MFAS 259 are provided for parties that require MFA, as NCT believes MFA and potentially other types of additional security will be required for any party interacting with the LS 250 at least those not using any of the ISPs 290.

As set forth in this patent application family, instances of the SGS 256 and LSS 252 may be paired and built as hardware from the ground up to serve as the cornerstone for the LS 250. From the beginning, the most challenging aspect of the LS 250 has been identified as safely interfacing the worldwide public with the LS 250, analogous to proving a negative. The SGS 256 is purely a safety mechanism, whereas the LSS 252 serves a first purpose as a safety mechanism and a second purpose as a local LS for real-time ownership records of VNs.

The SGS 256 and the LSS 252 may be produced as application-specific integrated circuits (ASICs). The SGS 256 and the LSS 252 may be built with minimal elements required for the functions implemented by the SGS 256 and the LSS 252 and no back doors of any type. The absence of back doors will be confirmed by the absence of unused physical ports confirmed by visual inspection, and of unused wireless capabilities confirmed using equipment such as a spectrum analyzer. For example, each of the SGS 256 and the LSS 252 may include elements such as a network interface card, power supply, multi-core, and DDR. The network interface card(s) for the LSS 252 may each implement a virtual private network to enable transfers with another instance of an LSS in the LS 250. The SGS 256 and LSS 252 must be invulnerable to threats while being understandable to personnel responsible for maintaining overwatch. The SGS 256 and LSS 252 may be built in a manner that does not leave providers of national digital currencies reliant on specific intermediaries for software updates. The simplicity of building minimalize instances of the SGS 256 and LSS 252 may enable storage of records of denominated VNs for conceivably all the parties in the world in a way that can be maintained and accessed quickly. Routing may be optimized when multiple units of the SGS 256 and LSS 252 are implemented so that multi-cores at the LSS 252 units can quickly perform the functionality attributed to LSS 252. GPUs with thousands of cores may be used for the LSS 252 rather than multi-cores with perhaps 24 or 48 cores to quickly perform the functionality attributed to LSS 252, which will reduce the required number of LSS 252 units. The LS 250 might require or at least benefit from the use of GPUs with thousands of parallel cores in the face of the demanding context presented by enormous volumes as will be the case with national digital currencies and perhaps other contexts such as exchanges.

The LS 250 may include one or more LSS 252, each matched with a different corresponding instance of the SGS 256. When denominated VNs are transferred between parties, the ownership of the denominated VNs may be transferred within the LSS when the intermediaries for both parties are assigned to the LSS, or to a different LSS when the intermediary for the recipient is assigned to the different LSS. Multiple instances of the LSS 252 may be divided by intermediaries such as by regions of a nation. Each LSS 252 may be paired with a SGS 256 that starts to inspect packets as initial security for compliance with the required SFIOI format. The packets, after passing the security check from the SGS 256, are forwarded to the LSS 252 for ownership checks as part of secondary security checks. The LSS 252 may include a default amount of dedicated physical space for each party, as well as larger dedicated physical space provided in advance for parties that may need more space. The larger dedicated physical space may also be dynamically allocated in real-time, such as when a party receives large amounts of denominated VNs unexpectedly, such as for graduating from high school or college. The LSS 252 may provide dedicated physical space for each party by grouping parties according to an intermediary assigned to the LSS 252. The dedicated physical space within the LSS 252 may include predetermined amounts of memory such as 64 64-bit fields, with 8 of the fields for each of 7 different denominations for the NDC.

The LSS 252 may perform blacklist checks as well as greylist checks as part of party identification fields for the parties in the dedicated physical space. The ownership checks are performed according to lookups for the dedicated physical space for the parties.

The LSS 252 may also counter double spending by providing a busy or not busy field in the dedicated physical space for each party. When an ownership check is to be performed for VNs purportedly owned by a party, the busy or not busy field for the party may be first checked. If the dedicated physical space is being used, the ownership check may be put back into a queue to impose a delay for a fraction of a second. When the dedicated physical space is available, the busy or not busy field may be made busy, and when usage of the dedicated physical space is complete, the busy or not busy field may be made available such as by flipping a bit to a busy state, and when usage of the predetermined physical space is complete the busy or not busy field may be made available such as by flipping the bit to the not busy state.

In some embodiments, the LSS 252 may use a graphics processing unit (GPU) to perform large volumes of ownership checks and other processing in parallel. A single DDR block and corresponding GPU may be used to maintain records for large numbers of parties, such as 10 or 20 million parties using identifications assigned by one or several intermediaries assigned to the LSS 252 that includes the DDR block and corresponding GPU. A single instance of the LSS 252 may include multiple DDR blocks and matched GPUs to optimize routing and lookups for incoming packets.

The MFAS 259 and ISPs 290 serve as additional components. Almost all SFIOIs will be provided via intermediaries such as via the ISPs 290. For the LS 250 to be open downstream, multifactor authentication will be required for parties who do not use a supervised intermediary, and MFAS 259 is therefore provided to be integrated with the LS 250. The ISPs 290 are not part of the LS 250, but are securely connected to the SGS 256 such as by hardwires or dedicated and persistent virtual private network (VPN) connections. The MFAS 259 may be part of the LS 250 or may also be securely connected to the SGS 256 such as by hardwires or dedicated and persistent VPN connections. These elements in FIG. 2A work together to ensure the secure and efficient management of VNs of an NDC. The elements of the LS 250 are currently expected to be the minimal elements for the LS 250 for a national digital currency (NDC), and will be spread around a nation while being able to provide real-time ownership confirmation of VNs to combat counterfeiting and fraud for example.

FIG. 2B illustrates a partial communications flow for the LS for tracking NDCs in FIG. 2A.

In FIG. 2B, a SGS 256 in the LS 250 receives SFIOIs from intermediary systems which are responsible for carrying the SFIOIs to the SGS 256. These SFIOIs may allow space for header information to be blank or partially populated outside of the header requirements for internet protocol formats such as IPv4 packets or IPv6 packets.

ISPs in the ISPs 290 may be interfaced with the SGS 256 such as by a dedicated cable with one or more individual wire or virtual private network (VPN) channel, and the SGS 256 may in some embodiments recognize the ISP system from such an interface.

ISPs are represented in FIG. 2B by a first ES 201 (endpoint system), a second ES 202, and a ninety-ninth ES 299. There is no particular limit to the number of ISPs that may be interfaced with the SGS 256 via a dedicated ES.

For SFIOIs in FIG. 2B, the ISPs may include intermediaries such as banks and other types of financial companies, communication service providers and consumer electronic companies. The ISPs may provide electronic wallet (EW) applications or similar applications to their customers, and one service provided by such applications may be to ensure the ability to safely carry SFIOIs to the SGS 256 such as by using encryption, dedicated lines, virtual private networks and so on. However, as a practical matter, the SGS 256 may refuse responsibility for decrypting incoming communications, insofar as the SGS 256 may be responsible for interfacing with numerous diverse known and unknown people and organizations. As a result, services provided by an ISP may include encrypted communications to an ES of the ISP, such as ESs interfaced with the SGS 256.

An ES may include one or more computers such as servers, as well as other types of communication and/or storage and/or processing devices used to terminate a private communications network for a provider of the private communications network. Each ES may be similar to a data center, even when multiple different ESs are provided in the same facility. The ES may also be used by the ISPs to initiate responses to their customers. The ESs may each be assigned a separate internet protocol (IP) address, or be connected by a dedicated line to the LSS 252 or another system controlled by the LS 250 provider and assigned an IP address. The ESs may receive communications for a plurality of customers over their corresponding private communications networks, and the communications may comprise packets in proprietary formats for the providers of the private communications networks or packets in a required packet format required by the SGS 256. Regardless of the type of format for packets received by an ES, the ES may be required to provide packetized communications to the SGS 256 in the required packet format for SFIOIs required by the SGS 256. In FIG. 2B, each ES is provided in a facility with a plurality of ESs each provided for a different private communications network. In other words, for many and likely most SFIOIs, encryption and other security mechanisms may be provided by ISPs all the way through ESs represented by the first ES 201, the second ES 202, through the ninety-ninth ES 299. As a result, the SGS 256 may not be required to maintain encryption/decryption keys. In some embodiments, the ISPs may be required to provide SFIOIs to the SGS 256 in the same format as the public, even if the ESs in FIG. 2B are hardwired or otherwise directly interfaced with the SGS 256.

Some or all of the ESs may be configured to send packetized communications to the SGS 256 for each of a plurality of customers in a required packet format for SFIOIs. The term packetized communications may include internet protocol (IP) packets such as internet protocol version 4(IPv4) packets and/or internet protocol version 6 (IPv6) packets. However, insofar as the ESs may be physically and/or logically interfaced with the SGS 256, the packetized communications are not necessarily otherwise compliant with an internet protocol version. The packetized communications still will comply with a SFIOI format, insofar as a variety of ISPs may send the packetized communications for their customers to the SGS 256. Each private communications network may be assigned its own unique identifier to use for communications sent to the SGS 256. Two bytes of sixteen bits total may be used to potentially uniquely identify more than 65,000 different providers, though even more than two bytes may be used when so allowed by the SFIOI format.

The addressing scheme for the SFIOIs routed through ISPs in embodiments herein may include space in the SFIOI for an identifier that identifies the ISP corresponding to the SFIOI. The identifier may be inserted at electronic wallet programs and/or currency reader programs when SFIOIs are generated on user devices, or may be first inserted at the ESs or at least within private communications networks managed by the ISPs and ending with an ES. The Intermediary field in the SFIOI format in FIG. 3A may be used for the identifier that identifies the ISP.

In some other embodiments, the ISPs may be identified at the SGS 256 by the dedicated channels, including dedicated lines, over which SFIOIs arrive from their ESs. For example, hardware at the SGS 256 may be configured to recognize each channel, and insert an identifier into the SFIOIs in reserved space so that even the ISPs are not aware of which identifier is assigned to them for internal processing at the SGS 256 and LSS 252. In some embodiments, equipment at the SGS 256 and LSS 252 may be dedicated permanently or semi-permanently to an ISP, such as a large ISP. In this way, SFIOIs that arrive over a channel dedicated to an ISP may be processed by hardware at the SGS 256 dedicated to that ISP. The use of dedicated equipment may improve efficiencies for large ISPs, though one of the benefits of a SGS 256 and LSS 252 as described herein is that the public may interact with the issuer of a digital currency without requiring use of any particular ISP such as a bank or large technology company.

Based on the teachings herein and in other patent filings by National Currency Technologies, Inc., governments and central banks may be able to implement LSs with elements such as the SGS 256 and LSS 252 without being forced to trust any particular entity, whether an individual, a financial institution, or a technology company. Of course, a government may choose to trust one or more ISPs, such as by waiving some or all of the security checks at the SGS 256. However, it should be clear that no government will be forced to trust any entity using the security mechanisms taught herein.

Despite the ability to treat all incoming SFIOS the same or at least potentially the same, some governments may allow some ISPs to place equipment within the SGS 256. For example, some very large ISPs such as Apple and Google may be allowed to place equipment within the SGS 256, such as within the same building, so that they can provide assurances that SFIOIs will be encrypted all the way into the SGS 256. In such embodiments, the decrypted SFIOIs may still be passed from the ESs within the SGS 256 to the processing systems of the SGS 256 for processing in the manners described herein.

To be sure, the current strategy for the LS 250 is now to receive SFIOIs at the SGS 256 for initial security checks, and then pass information from SFIOIs to the LSS 252 for ownership checks as secondary security checks. The LSS 252 performs ownership checks by confirming whether ownership listed in a SFIOI in the VN ID fields is correct for at least one tracked digital asset listed in the VN ID fields, though the initial intent is to check ownership for SFIOIs listed in any of the populated VN ID fields. The LSS 252 will also initiate disposition according to a second specified field (e.g., the SFIOI Type field) at a second predetermined relative location of the payloads of the SFIOIs. For example, the SFIOI type filed may be the 116th byte (out of 128 bytes) and may specify the type of inquiry or instruction requested by party #1 when the SFIOI was generated.

-In FIG. 2B, a SGS 256 in the LS 250 receives packets from intermediary systems which are responsible for carrying the packets to the SGS 256. ISPs in the ISPs 290 may be interfaced with the SGS 256 such as by a dedicated cable with one or more individual wire or virtual private network (VPN) channel, and the SGS 256 may in some embodiments recognize the ISP system from such an interface. ISPs are represented in FIG. 2B by a first ES 201 (endpoint system), a second ES 202, and a ninety-ninth ES 299. There is no particular limit to the number of ISPs that may be interfaced with the SGS 256 via a dedicated ES.

The addressing scheme for the packets routed through ISPs in embodiments herein may include space in the SFIOI format for an identifier that identifies the ISP corresponding to the packet. Based on the teachings herein and in other patent filings by National Currency Technologies, Inc., governments and central banks may be able to implement LSs with elements such as the SGS 256 and LSS 252 without being forced to trust any particular entity, whether an individual, a financial institution, or a technology company.

The current strategy for the LS 250 is now to receive packets at the SGS 256 for initial security checks, and then pass information from packets to the LSS 252 for ownership checks as secondary security checks. The LSS 252 performs ownership checks by confirming whether ownership listed in a packet in the VN ID fields is correct for at least one tracked digital asset listed in the VN ID fields, though the initial intent is to check ownership for packets listed in any of the populated VN ID fields. The LSS 252 will also initiate disposition according to a (second) specified field at a second predetermined relative location of the payloads of the packets. For example, the SFIOI type field may be the 116th byte (out of 128 bytes) and may specify the type of inquiry or instruction requested by Party #1 when the packet was generated.

FIG. 3A illustrates an example format for a SFIOI as now updated.

The format for an SFIOI shown in FIG. 3A is a 128-byte format. In previous descriptions, the SFIOI format was 512-bytes and included empty space for several purposes, including flexibility for future uses and status space towards the end of the format set aside for status updates when different threads executed by different cores of a multi-core processor have to be synchronized by each thread checking completion of previous tasks before proceeding and by updating the dedicated status space for their own task after proceeding. The format of the SFIOI in FIG. 3A specifies requirements for fields at predetermined relative locations of payloads of acceptable SFIOIs. The payload of an SFIOI may be the entirety of the SFIOI except for the header. The SGS 256 processes SFIOS to confirm compliance with the required format by having each algorithm process packets by implementing one or a plurality of safety checks by checking data in the fields at the predetermined relative locations of the payloads of the SFIOIs. As an example, a (first) specified field at a first predetermined relative location of the payload of the SFIOI in FIG. 3A may be the last byte of the Tracking Status field at the end of the SFIOI format. The Tracking Status field may be updated with a value corresponding to any safety check that is not passed. For example, a first possible error may be when the Origin field does not have the proper value, so the Tracking Status field may be updated with a “1 value. As another example, a second possible error may be when the VN Count value does not match the number of VN ID fields that are substantively populated in the SFIOI, so the Tracking Status field may be updated with a “2” value. When any of a plurality of safety checks performed by an algorithm on a SFIOI are not passed, processing of the SFIOI with safety checks by the algorithm may be ended and the algorithm may send the SFIOI with the updated value in the Tracking Status field on for disposition.

In FIG. 3A, the fields are shown in sixteen (16) 64-bit words, and include a header word #1, a header word #2, a header word #3, a combined word with VN Count and VN Origin ID, a first party ID word, a second party ID word, seven VN ID words, an eighth (8th) VN ID word for change, a combined word with SFIOI type and Intermediary ID, and a final word for tracking statuses. Although three header words are shown, in the future the format shown in FIG. 3A may be adjusted to provide five (5) or even more header words such as for IPv6 packets sent over the open internet, wherein space for the extra two header words may be provided by packing the other words to eliminate unused space and/or duplicative information in the format shown in FIG. 3A.

The Intermediary ID field in the SFIOI format shown in FIG. 3A is a recent update to the original SFIOI formats from earlier years. The SGS 256 receives packets from a plurality of intermediaries via the ISPs 290 and the SFIOI format specifies that each SFIOI received from an intermediary should have the Intermediary ID field marked with an identification of the intermediary so that a response to the SFIOI can be returned via the intermediary according to the identification.

Another recent update is that the response to the SFIOI is returned from the LSS 252 rather than from the SGS 256, as this greatly reduces complexity of processing at the SGS 256. Indeed, for the status tracking word in the SFIOI format in FIG. 3A, a status only needs to be written once if and when an error is found, as the error can be specified by the value corresponding to the error. The status tracking word may be reduced to a single byte for example, as this will allow for specifying as many as 256 different errors and is more than enough for the processed NCT has contemplated so far.

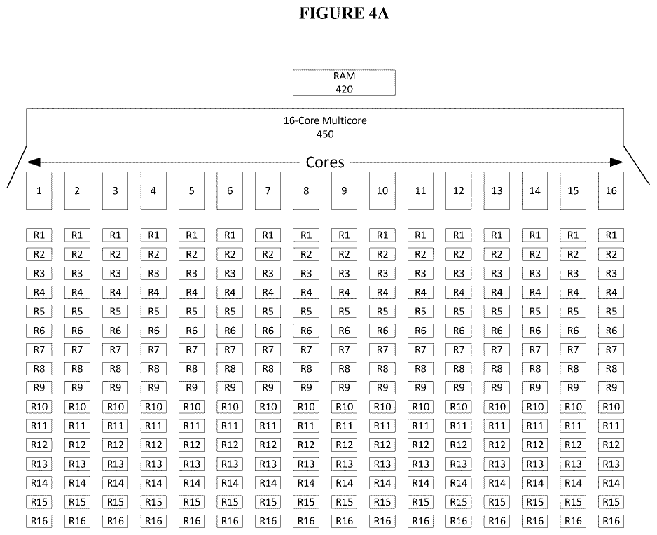

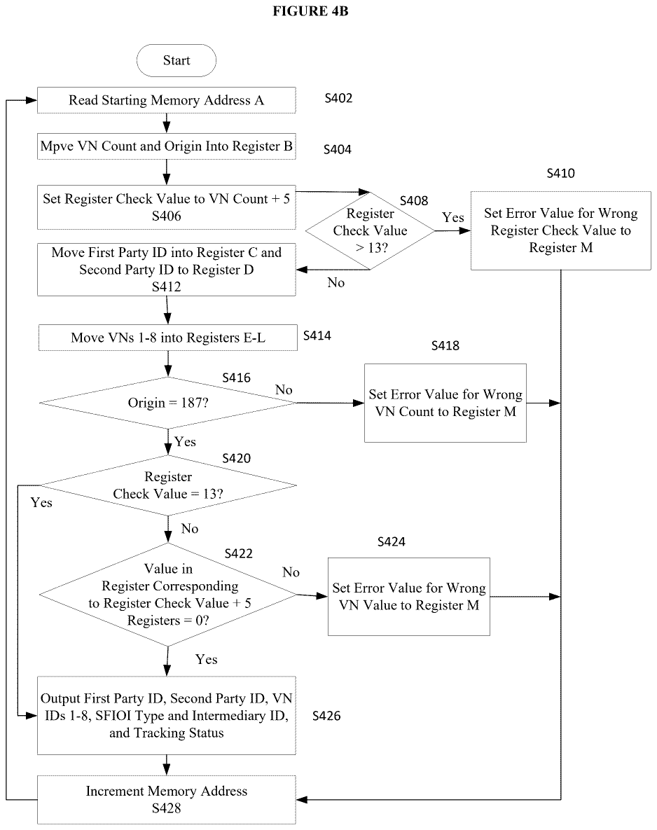

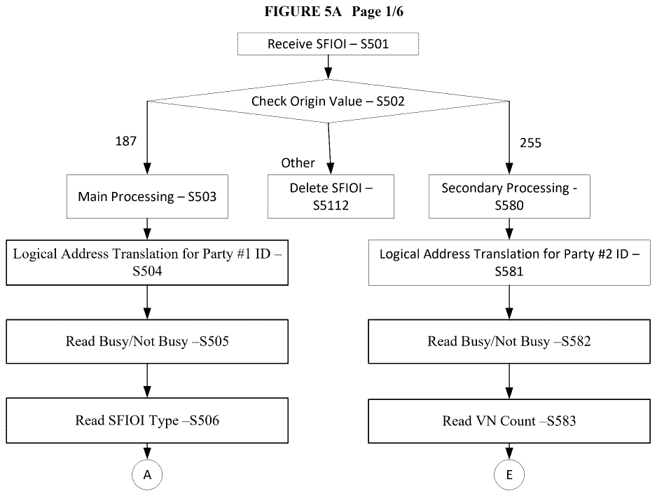

In the format for SFIOIs shown in FIG. 3A, two separate fields are combined in the fourth (4th) word. VN Count and VN Origin ID are combined in the fourth word as the first word after the three header words, as VN Count and VN Origin ID are the subjects of the two security checks performed in the project resulting in the descriptions herein. Two separate fields are also combined in the fifteenth (15th) word. The sixteenth (16th) status tracking word may be or include a (first) specified field at a first predetermined relative location of the payloads of the packets and may be updated when any safety check is not passed by the algorithm populating the status tracking word with a value corresponding to the safety check that is not passed. Examples of populating the status tracking word with a value corresponding to an error are shown by S410, S418 and S424 in FIG. 4B.

To be abundantly clear, the 128-byte SFIOI format shown here is not necessarily final. The same is true as to the format size, the data types in the fields, the data sizes in the field, the arrangement of fields, or other characteristics of the SFIOI format in FIG. 3A. Moreover, the SFIOI format can be adjusted for uses outside of NDCs, including for anything from tokens representative of rights for real world assets to government ledger records for homes or vehicles. Rather, the SFIOI format in FIG. 3A will be understood as representing the consistent concepts in NCT's patent filings that a fixed format with requirements for data in predetermined relative locations can be used as a security feature.

-FIG. 3B illustrates an alternative view of the current example SFIOI format.

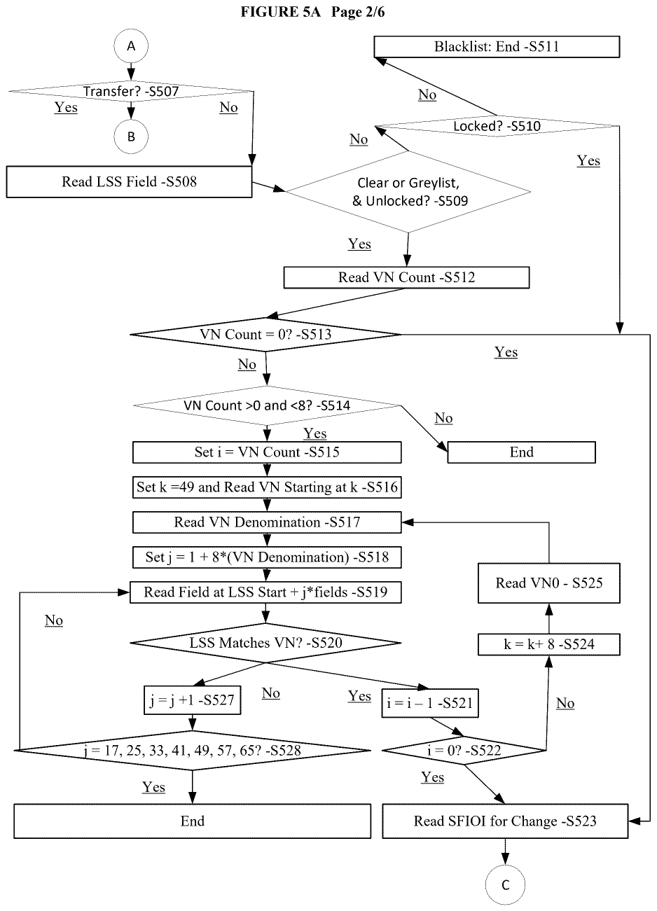

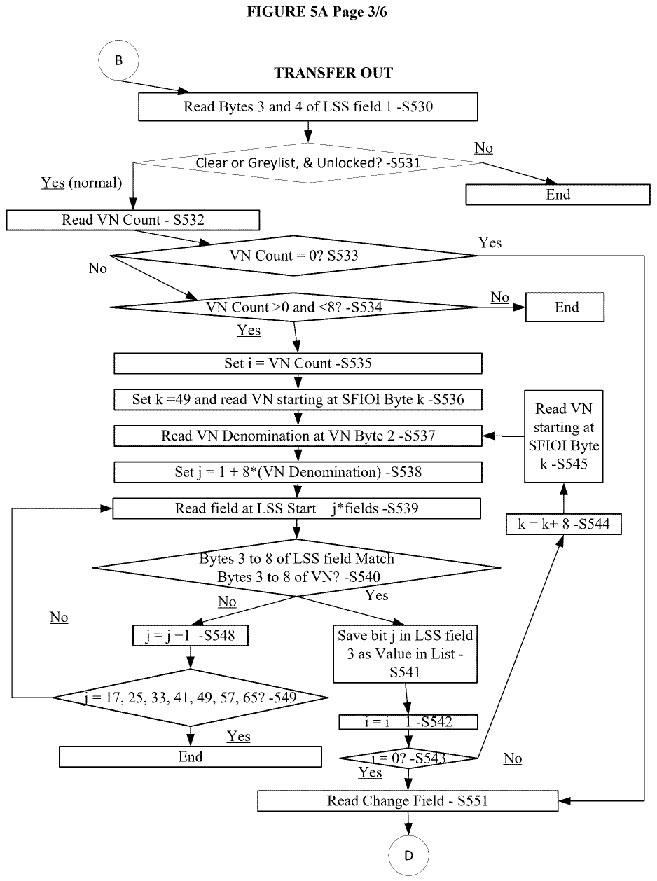

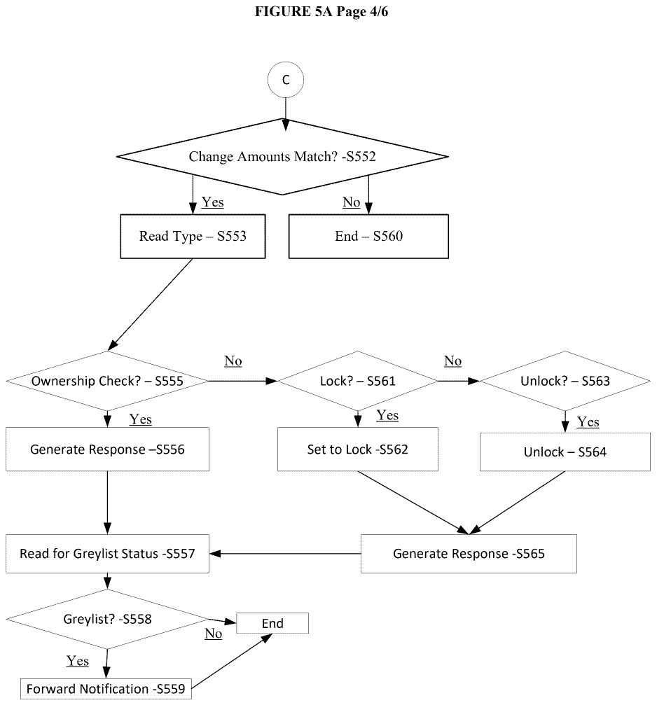

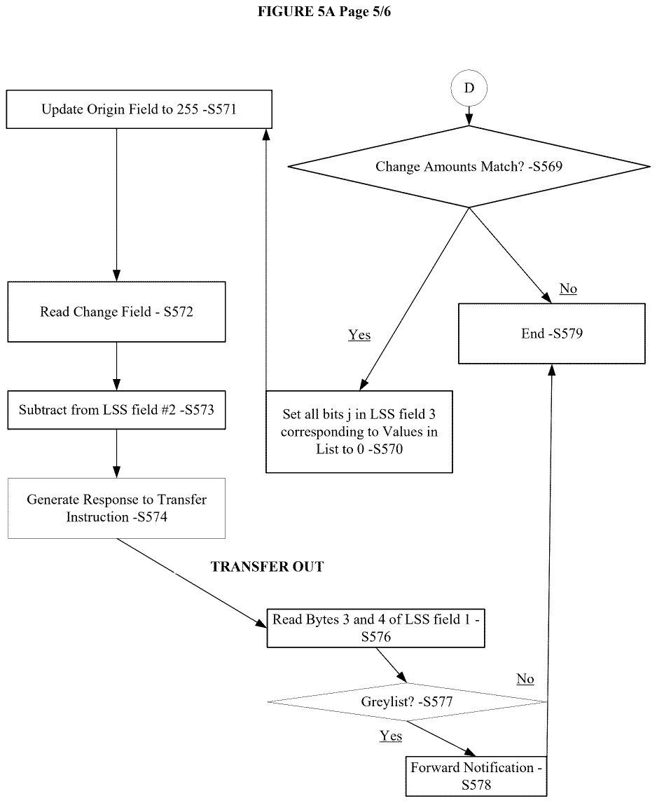

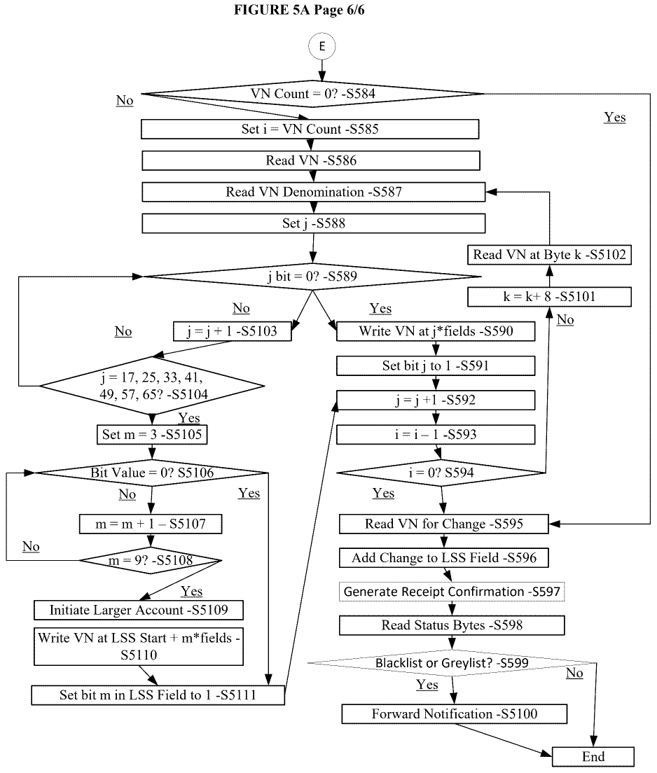

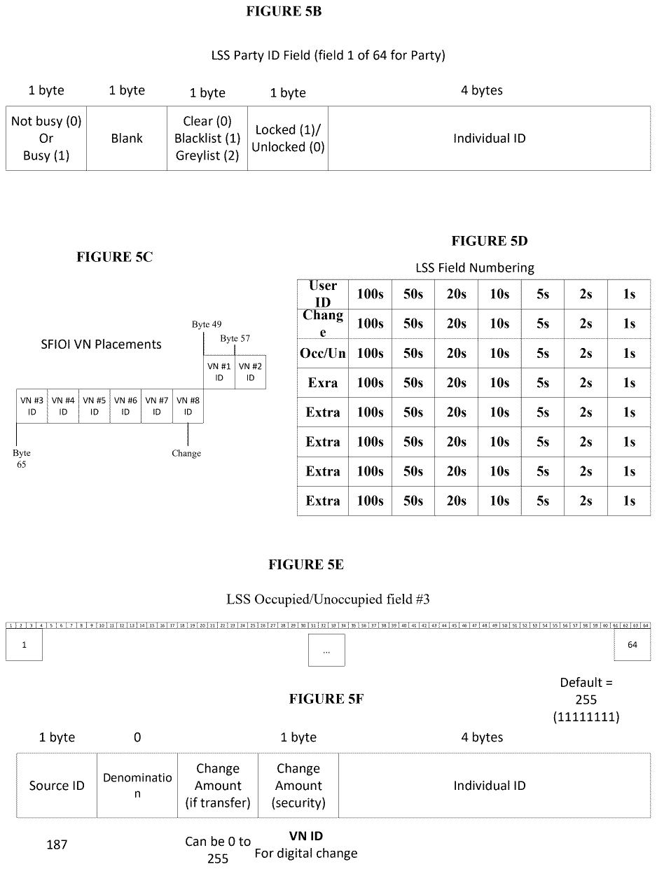

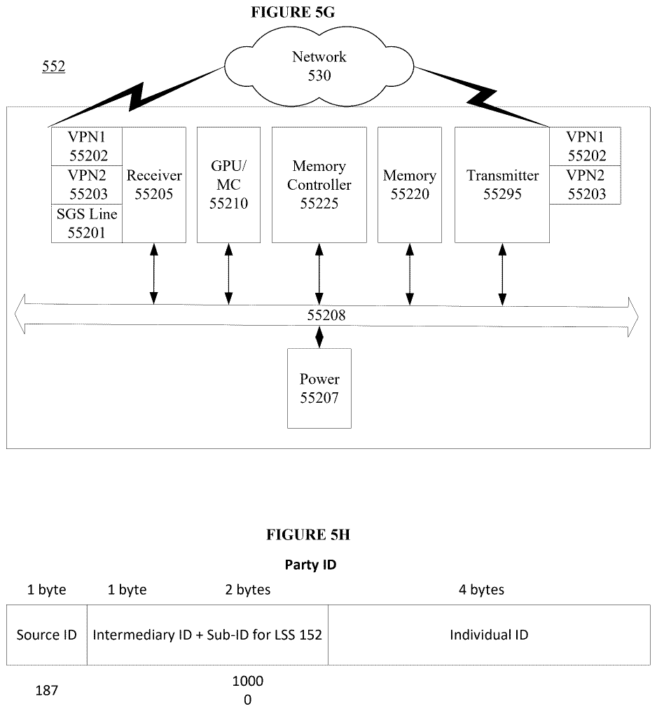

In the SFIOI format in FIG. 3B, the VN Count may be used for a fast dynamic security check at the SGS 256 for comparison with the actual number of VNs listed in the packet. The Origin may be used for a static security check at the SGS 256 for comparison with the assigned value for the source of the VNs in the packet, with “187” assigned to the United States during testing. The Party #1 ID always represents the purported owner of all VNs listed in the packet, and this is checked at LSS 252. VN #8 includes a field for a slow dynamic security check, also at the LSS 252, for comparison with the current amount of change in the LS 250 for Party #1. All three of these comparisons require an exact match with the expected value, and the expected value for the VN Count may vary for each SFIOI depending on how many VNs are actually present in the packet, and the expected value for the change may vary as amounts of change increase and decrease with activity. The VN #8 field for the SFIOI format is shown in and described with respect to FIG. 5F. The optimized SFIOI format in FIG. 5F can accommodate all nations on Earth, all intermediaries on Earth, and all end users on Earth as long as they have access to the Internet in some manner. The VNs specified in FIG. 3B emulate denominated and serialized notes of a physical currency, though the LS 250 may be implemented for cryptocurrencies, stablecoins, tokens and other digital assets. For example, a serialized and denominated stablecoin may be issued based on United States dollars or another fiat currency, and records may be maintained by an LS 250 and the SFIOI format described herein.

FIG. 4A illustrates a module configuration for an SGS.

In FIG. 4A, an SGS 456 includes a RAM 420 and a 16-core multicore 450. The RAM 420 may comprise a DDR4 or DDR5 memory and is byte-addressable. Each of the sixteen (16) cores of the 16-core multicore 450 is provided with sixteen (16) registers labeled R1 through R16. Each register may be configured to store eight (8) bytes during operations by the core executing the algorithm using the registers dedicated to the core.

FIG. 4B illustrates a method of processing SFIOIs at an SGS. In the method for processing SFIOIs for NDCs in FIG. 4B, the method represents an example of how an SFIOI may be processed at the most granular level using registers (e.g., sixteen (16) registers) dedicated to a single core of a multi-core processor. Abstraction of the functionality is minimized so that the SGS 256 minimizes trust in hardware functionality it does not control. The abstraction involves trusting a memory controller to track physical addresses where SFIOIs are temporarily stored, and then otherwise directly addressing the relative locations of the SFIOIs where specific data is stored.

At S402, a starting memory address A is read. The starting memory address A is a starting physical memory address where a SFIOI is stored in a DDR memory upon receipt from one of the intermediaries. Notably, the simplified flowchart in FIG. 4B assumes that the entire SFIOI is stored together starting at the starting memory address A. Additionally, the SFIOI used for this example flowchart assumes that up to eight (8) VNs are specified in the SFIOI, which is different from the example SFIOI formats in FIG. 3A described above which assume up to seven VNs are specified in the SFIOI and the eighth VN field is used to specify change.

At S404, the VN_Count and Origin are moved into register B. Register B and other registers described herein may store eight (8) bytes, such that the 64-bit (8-byte) fields of the SFIOI match the size of the registers exactly. The VN_Count and Origin fields in the SFIOI format described herein are provided together as these were the (only) two fields checked during the project resulting in the descriptions herein.

At S406, a Register Check Value is set to the VN_Count+5, which reflects the assumption that the maximum number of VNs in an SFIOI in the example of FIG. 4B herein is eight (8).

At S408, a determination is made whether the Register Check Value is greater than 13. If the Register Check Value is 14 or higher, this would mean that the VN_Count was set to 9 or higher, which would be above the maximum expected size for the VN_Count.

If the Register Check Value is greater than 14 (S408=Yes), at S410 an error value is set for a wrong Register Check Value in Register M, after which the memory address is incremented at S428, and the process returns to S402 to read the starting memory address and restart the checks for the next SFIOI.

If the Register Check Value is not greater than 14 (S408=No), at S412 the First Party ID is moved into Register C and the Second Party ID is moved into register D.

At S414, VNs 1-8 are moved into Registers E-L. More particularly, the information in the fields for VNs 1-8 are moved into Registers E-L, regardless of what information is included in the fields.

At S416, a check is made for whether the Origin field is equal to 187. 187 is used as the Origin value for the United States in this example. If the Origin value does not equal 187 (S416=No), at S418 an error value is set for a wrong Origin in Register M, after which the memory address is incremented at S428, and the process returns to S402 to read the starting memory address and restart the checks for the next SFIOI.

At S420, a determination is made whether the Register Check Value is equal to 13, as this would mean that all VN fields should be occupied in the SFIOI.

If the Register Check Value is equal to 13 (S420=Yes), the process proceeds to S426 since an error check for the VN_Count cannot be made because all eight (8) VN fields should be populated. Notably, this assumes the check starting at S420 is only looking for the first unpopulated field to be empty. If the check is also or alternatively looking for whether populated fields are empty when they should not be, S420 may be omitted, and subsequent steps may be adjusted accordingly. At S426, the First Party ID, the Second Party ID, VN IDs 1-8, SFIOI Type and Intermediary ID, and Tracking Status are output after which the memory address is incremented at S428, and the process returns to S402 to read the starting memory address and restart the checks for the next SFIOI.

If the Register Check Value is not equal to 13 (S420=No), a determination is made at S422 for whether the value in the register corresponding to Register Check Value+five is equal to zero (0), as this register should be empty. If the value in the register corresponding to Register Check Value+five is not equal to zero (0) (S422=No), at S424 the error value for the Wrong VN value is set to Register M, after which the memory address is incremented at S428, and the process returns to S402 to read the starting memory address and restart the checks for the next SFIOI. If the value in the register corresponding to Register Check Value+five is equal to zero (0), the SFIOI passes this second security check and at S426 the First Party ID, the Second Party ID, VN IDs 1-8, SFIOI Type and Intermediary ID, and Tracking Status are output after which the memory address is incremented at S428 and the process returns to S402 to read the starting memory address and restart the checks for the next SFIOI.

Accordingly, after S410, S418, S424 and S426, the iterative method of FIG. 4B always ends up incrementing the memory address at S428 to move to processing the next SFIOI.

In the method of FIG. 4B, a single algorithm performs multiple safety checks on a SFIOI rather than coordinating (e.g., synchronizing) different algorithms to each perform different safety checks. This avoids the possibility of memory access conflicts and reduces both processing complexity and space dedicated to status updates in coordinating the different algorithms. Additionally, in the method of FIG. 4B, the SFIOIs are sent to the LSS 252 whether errors are found or not, as the LSS 252 initiates disposition of SFIOIs by initiating the responses to the parties sending the SFIOIs. This reduces processing complexity at the SGS 256 by not requiring the SGS 256 to wait for responses to the ownership checks at the LSS 252. Moreover, the memory used to temporarily store SFIOIs during processing by an algorithm may be the registers when SFIOIs are immediately processed without being stored in a byte-addressable memory such as a DDR4 or DDR5, but otherwise may be the DDR4 or DDR5 or another form of byte-addressable memory. The memory will specifically not be flash or other conventional memory forms which are only read from and written to as pages such as 512 bytes at a time.

During the project resulting in the descriptions herein, NCT was able to process approximately 250,000 SFIOIs per second using a single algorithm executing using a single thread run by a single core, and approximately 1,000,000 SFIOIs per second using four instances of the algorithm. For the purposes of the SGS 256, this is a much greater volume than necessary given that multiple SGSs with multiple ASICs each with a multi-core may be used for the LS 250. Inasmuch as the current 128-byte SFIOI format has an Origin field that accommodates all nations, the SGS 256 and SFIOI format may be usable anywhere in the world for an NDC or for a variety of other digital assets or digital representations of physical assets that may be recorded on a ledger system such as the LS 250.

FIG. 5A illustrates a method for processing packets at an LSS. The method of FIG. 5A may be performed by or using a core of a multicore or GPU executing a program written in C or C-Cuda, compiled to assembly language, and transferred to the multicore or GPU. This is similar to how methods performed by the SGS 256 are implemented.

At S501, a packet is received at an LSS. The packet may be received by an LSS 252 from a SGS 256, or the LSS 252 may be received from another instance of a LSS in the LS 250 based on a transfer instruction received at the other instance of the LSS 252.

At S502, an Origin value in the received packet is read. For example, the Origin value may be expected at Byte 32 of the received packet. The Origin value is checked for several reasons, including to be sure the packet is being received at the proper instance of the LS 250, such as when multiple LS each use the same SFIOI format and the first check to be made for a received packet is to be sure the received packet was sent to the proper instance of the LS 250. The example value used at the time of writing of this description is 187 for the United States when the received packet is being received from a supervised intermediary or directly from a member of the public. A second reason for checking the Origin value is to determine whether the SFIOI is being received as an internal transfer rather than a transfer through the SGS 256. S574 explained below is when a transfer instruction is generated, and if the transfer is to be to another instance of the LSS 252, the processing at S502 will be applied. If the transfer is to the same instance of the LSS 252, the SFIOI may simply start at S502 when the SFIOI is put back into queue from S574. A third reason for checking the Origin value is as a security check, as not having a value for the proper instance of the LSS (187 in these examples) or for an internal transfer (which uses the number 255 in these examples), the SFIOI can be deleted at S5112.

At S503, a main processing is initiated, when the received packet has the proper value from a supervised intermediary or directly from a member of the public, so 187 for the United States in the example above at the start of the description of FIG. 5A. S5112 is described below for when the packet is deleted when the SFIOI Origin value is not any of the values used at the LSS 252. S580 is described below and initiates secondary processing when the received packet is from an internal transfer from another instance of a LSS in the LS 250, so 255 in the example above at the start of the description of FIG. 5A.

At S504, logical address translation is performed for the Party #1 identification in the packet. Since VN identification are stored for parties according to party ID, and insofar as the Party #1 identification is for the purported owner of the VNs listed in the packet, the dedicated physical memory space for the purported owner must be checked at the LSS 252. Therefore, at S504 logical address translation is performed to look up the physical memory space for the purported owner listed in the Party #1 identification. The LSS 252 may keep a lookup table or another type of logic arrangement to efficiently perform the logical address translation at S504, so party identifications and the starting physical memory address of the dedicated physical memory space for each party. The physical memory addresses may be, for example, DDR4 or DDR5 memory addresses, arranged by bank group, bank, row and column for the starting physical memory address. S504 may also involve routing to one of several units of the instance of the LSS 252 according to the Party #1 identification.

At S505, a busy/not busy field is read in the dedicated physical memory space for the Party #1 identification. For example, byte 1 of the first field of sixty four 64-bit fields in the dedicated physical memory space may be used to mark when the dedicated physical memory space is already busy. If the dedicated physical memory space is busy, a wait may be imposed until the dedicated physical memory space is not busy, such as by putting the packet back into a queue to restart the method of FIG. 5A at S501 again, or otherwise using a counter at the core performing the method of S501 to count down a predetermined number of clock cycles. If the dedicated physical memory space is not busy, then the busy/not busy field is changed to mark the dedicated physical memory space busy, such as be changing a value of the byte from 0 to 255 or another value used to mark a busy status.

At S506, a type field is read in the dedicated physical memory space for the Party #1 identification. For example, byte 4 of the fifteenth field of the SFIOI format may be used to specify the type of SFIOI. The type field is read early in the process at S506 because the process will substantially branch at S507 depending on whether the SFIOI is for a transfer or for another reason. By comparison, if an SFIOI is received as an internal transfer as determined at S502/S508, security processing such as proactive ownership confirmations have already been performed and the processing at S83 skips reading the type field and proceeds to immediately read the VN count in the SFIOI.

At S507, a determination is made whether the SFIOI type indicates a transfer. If the SFIOI type indicates a transfer (S506=Yes), processing moves to S530. However, if the SFIOI type does not indicate a transfer (S506=No), a complex process is performed beginning for other types such as ownership checks, and locks and unlocks of VNs for a party at the dedicated memory space for the party. The complex process starts by proactively performing ownership confirmation for the VNs listed in the packet to be sure they are owned by the party corresponding to Party #1 identification in the SFIOI format. The LSS 252 is configured to proactively confirm ownership of the instances of the tracked digital asset such as VNs listed in acceptable packets without transferring ownership of the instances of the tracked digital asset listed in the acceptable packets as a disposition among a plurality of possible dispositions according to a value in a (second) specified field at the (second) predetermined relative location. The type field is used to specify a disposition among a plurality of possible dispositions, and thus may be referred to as a (second) specified field at the (second) predetermined relative location, whereas the tracking status field is used to track status of a SFIOI during processing, and thus may be referred to as the (first) specified field at the first predetermined relative location.

At S508, a predetermined field in the dedicated physical memory space for the Party #1 at the LSS 252 is read to see if the party is clear and otherwise unlocked or on a greylist and otherwise unlocked. For example, the predetermined field for S508 may be bytes 3 and 4 of the first of sixty four 64-bit fields of the dedicated physical memory space for Party #1. The normal expected status for a party at LSS 252 will be clear, though some parties may be on a greylist that indicates to send a notification such as to a law enforcement agency when packets for the party are received, and some parties may be on a blacklist that indicates no transfers of packets from the party allowed such as pursuant to a judicial order. Additionally, a party may be enabled to lock (and unlock) their VNs, similar to how individuals place physical currency in safe deposit boxes or under a mattress for safekeeping.

At S509, a determination is made whether the predetermined field at S508 indicates both a clear and otherwise unlocked status or a greylist and otherwise unlocked status.

At S510, if the predetermined field at S508 is not clear or greylist, and/or is not unlocked (S509=No), a determination is made as to whether the status corresponds to locked. If the status at S509 is locked for Party #1 (S510=Yes), the process moves to S523.

At S511, if the status at S509 is not locked for Party #1 (S510=No), and has already been determined to not be clear or on a greylist, the party must be on a blacklist, so the busy/not busy field is set to not busy and the processing for the packet ends. The blacklist status for Party #1 may mean that no responses are generated for packets and no transfers of VNs for Party #1 are allowed. Of course, other processing may be performed for blacklisted parties, but for the purposes of the descriptions herein the blacklist status is one of several different types of statuses that may be maintained for parties at the LSS 252.

At S512, if the status of Party #1 is clear and unlocked or on a greylist and unlocked (S509=Yes), the VN count for the packet is read. The VN count may be maintained, for example, in the fourth byte of the fourth of sixteen 64-bit fields for packets, so byte twenty eight.

At S513, a determination is made as to whether the VN count for the packet is zero, such that no VNs are listed in the packet. If the VN count is zero (S513=Yes), the process moves to S523. S513 and S510 both lead to S523 insofar as a locked determination at S510 for a non-transfer type of SFIOI determined at S507 may presumably be for an unlock type of SFIOI, and insofar as a VN Count determination of 0 VNs at S513 for an unlocked party determined at S509 may presumably be for a lock type of SFIOI. A determination at S553 shows only three types of non-transfer types of SFIOI including lock, unlock and ownership check. Of course, an LS 250 may provide more or fewer than three types of non-transfer instructions and/or other types of non-transfer instructions. The example types described herein are consistent with the functionality described with respect to FIG. 5A.

At S514, if the VN count is not zero (S513=No), at S513 a determination is made whether the VN count is between zero and eight. Eight is set as the upper limit for this determination since the highest number of VNs that may be listed in the example SFIOI format is seven. If the VN count is not between zero and eight at S514 (S514=No), the process ends.

At S515, if the VN count is between zero and eight (S514=Yes), a variable i is set as the VN count to begin iteratively processing the VNs in the packet.

### Dual Use of the VN Count

The VN count in a SFIOI is used for a countdown in FIG. 5A starting at S515 and/or at S535 and at S585. Here, the VN count provides a marker that can be used in an iterative process as VNs in a SFIOI are checked for ownership confirmations (S515 and S535) or for transfers to new owners (S585). Having a proper count of the number of VNs to confirm or transfer ensures efficiency so that the LSS 252 knows when the iterative processes are complete in terms of all VNs in a SFIOI being confirmed or transferred. This is a second use for the VN count, as the VN count in the SFIOI is used also for one of the initial security checks at the SGS 256, by checking the stated number of VNs in the VN count versus the actual number of VN ID fields populated with VN IDs in the SFIOI. The SFIOIs may be passed as-is from the SGS 256 to the LSS 252 and between instances of the LSS 252, or may be selectively pared down to replace substantive data such as any header information with a filler value such as all 0s or all 1s.

At S516, a variable k is set to a predetermined value corresponding to a byte position in the packet, and the VN is read starting at the byte position corresponding to the predetermined value to which k is now set. For example, k may be set to forty nine as the first byte of VN #1 in the packet. The forty ninth byte corresponds to the first byte of the seventh 64-bit field of the packet in this example.

At S517, the second byte of the VN is read to obtain the VN denomination of the VN. The denomination is used to determine the relative locations to check for the VN in the dedicated physical memory space for the party. For example, in FIG. 5D, the ninth through sixteenth fields of the dedicated physical memory space for a party are dedicated to denominations of 100s, corresponding to digital VNs for $100 in the case of the United States. The seventeenth through twenty fourth fields are dedicated to denominations of 50s, the twenty fifth through thirty second fields are dedicated to denominations of 20s, the thirty third through fortieth fields are dedicated to denominations of 10s, the forty first through forty eighth fields are dedicated to denominations of 5s, the forty ninth through fifth sixth fields are dedicated to 2s, and the fifty seventh through sixty fourth fields are dedicated to 1s. The dedicated physical memory space in FIG. 5D provides sixty four fields, though more or fewer fields may be provided as a default, and parties may be provided an ability to obtain more than a default memory space both in advance as well as dynamically in real-time such as when a party receives more VNs than the party has space for in their dedicated physical memory space. The dedicated physical memory space in FIG. 5D may be increasable in advance for parties that may need more space to store records of current ownership of instances of the tracked digital asset such as VNs. The dedicated physical memory space in FIG. 5D for a party may also be increasable in real time when a party receives an amount of VNs exceeding capacity at the dedicated physical memory space for the party.

At S518, a variable j is set to 1 plus 8*(the VN denomination). Here the VN denomination may correspond to a relative rank of the valuation of the VN among all possible values, so 1 for the 100s, 2 for the 50s, 3 for the 20s, 4 for the 10s, 5 for the 5s, 6 for the 2s, and 7 for the 1s. In this configuration, and as shown in FIG. 5D, the variable j may be set to 9 for a VN with a VN denomination of 100 as the highest rank among potential denominations.

At S519, the field at the LSS 252 among the dedicated physical memory space for Party #1 and starting at the field j corresponding to the variable j from S518 is read.

At S520, a determination is made whether the serial number for the VN matches with a serial number at the jth field is a match. For the first iteration of up to eight iterations in the column for 100s in FIG. 5D, this means checking to see whether the VN matches the ID of any VN stored at the 9th field in the dedicated physical memory space. The serial number may correspond to the third to eighth bytes of a VN ID, so the comparison at S520 may be a comparison of the third to eighth bytes of the VN ID and the third to eighth bytes of the corresponding field in the dedicated physical memory space.

At S521, if the VN ID matches the ID in the corresponding field of the dedicated physical memory space (S520=yes), i is decremented by 1 to check the next VN in the packet if there is a next VN in the packet.

At S522, a determination is made as to whether i=0 after the decrementing at S521. If i=0 at S522 (S522=Yes), the process moves to S523.

At S523, the Change field in the SFIOI is read. In the SFIOI format shown in FIG. 3B, the Change field is the VN #8 field. For example, the Change field may be the fourteenth field of the example 128-byte SFIOI format described in this patent application family, so bytes 105 through 112.

At S524, if i does not=0 at S522 (S522=No), k is incremented by 8 to initiate reading of the next VN in the packet since there was a match of the current/previous VN in the packet at S520.

At S525, the VN in the packet starting at the updated byte k is read, and the process returns to S517 to check the denomination for the new VN to be checked for a match. Thus, the process from S517 through S525 is for finding a match between a VN in a packet and a VN record in the dedicated physical memory space for a party at the LSS 252. This match confirms ownership by Party #1 of the VN being checked from the packet.

If the VN Count is not between 0 and 8 at S514 (S514=No), the process ends. The processing of the packet is ended when the VN count being checked in the packet is not in an expected range (S514=No), which is between 0 and 8 in the example SFIOI format being used in this patent application family. To end processing, byte 1 of the first LSS field for busy/not busy is made to not busy and the processing of the packet ends.

At S527, if there is no match for any VN being checked at S520 (S520=No), the next potential field in the dedicated physical memory space for the party at the LSS 252 is checked so j is incremented by 1, so j=j+1.

At S528, a check is made as to whether j is now equal to any of 17, 25, 33, 41, 49, 57 or 65 after the incrementing at S527, as this would indicate that the incrementing has put the value of j at the top of the next denomination such that all of the fields for the intended (previous) denomination have been checked. In other words, S528 may be considered a check for a match in the denomination column. If j is not equal to any of 17, 25, 33, 41, 49, 57 or 65 (S528=No), the method returns to S519 so that the next field in dedicated physical memory space at the LSS 252 can be checked.

If j is equal to any of 17, 25, 33, 41, 49, 57 or 65 at S528 (S528=Yes), the processing of the packet is ended because the VN being checked for ownership is not a match for any of the VNs listed in the denomination space for the party at the LSS 252. A failure to match even a single VN in a packet is enough to justify ending processing for the packet. To end the process after S528 or anywhere else in FIG. 5A, byte 1 of the first LSS field for busy/not busy is made to not busy and the processing of the packet ends. When the processing of the packet is ended at any time in FIG. 5A, the busy/not busy field of the LSS for the party is marked not busy, such as by flipping a bit from 1 to 0 or from 0 to 1. The busy/not busy field may be, for example, byte 1 of the first LSS field for the party.

To be sure, the process from S512 through ending after S528 is an iterative process to count down i VNs starting at the jth field for the denomination of each VN and starting at the kth byte of the packet. Therefore, i is iterated down, j is iterated up, and k is a fixed starting point for where to start reading VNs in the packet.

At S530, a predetermined field of the LSS for the party is read to check for whether the LSS space for the party is unlocked and clear or unlocked and grey. For example, bytes 3 and 4 of the first LSS field for the party may be checked for whether the LSS space for the party is unlocked and clear or unlocked and grey.

At S531, a determination is made as to whether the status read at S530 is unlocked and clear or unlocked and grey.

At S532, if the party space at the LSS for Party #1 is unlocked and the party status is either clear or on a greylist (S531=Yes), the VN Count in the SFIOI field is read to begin another iterative process. The processing at S532 may be considered the “normal” processing at the LSS 252, insofar as most SFIOIs are expected to be for transfers between parties authorized to make transfers. The VN Count may be, for example, at byte #28 of the packet, so byte #4 of the fourth field of the packet.

At S533, a determination is made as to whether the VN count is zero (0). If the VN count is zero (0) (S533=Yes), the packet is for a transfer (S507=Yes), the LSS space for the party is unlocked and the party is not on a blacklist (S531=Yes), the party is assumed to be transferring change, and processing moves to S551

At S534, if the VN count is not zero (0) (S533=No), a determination is made as to whether the VN count is above zero (0) and below eight (8). The actual number of VNs allowed in the SFIOI format used herein is seven, so if eight or more VNs are specified in the VN Count S534=No), the packet has an error, and the process ends at S547.

At S535, if the VN count is between zero (0) and eight (8) (S534=Yes), a variable i is set to the VN Count. The VN Count is then used as a counter for a countdown to begin iteratively processing the VNs in the packet.

At S536, a variable k is set to a predetermined value corresponding to a byte position in the packet, and the VN is read starting at the byte position corresponding to the predetermined value to which k is now set. For example, k may be set to forty nine as the first byte of VN #1 in the packet. The forty ninth byte corresponds to the first byte of the seventh 64-bit field of the packet in this example.

At S537, the second byte of the VN is read to obtain the VN denomination of the VN. The denomination is used to determine the relative locations to check for the VN in the dedicated physical memory space for the party, as explained with respect to S517.

At S538, a variable j is set to 1 plus 8*(the VN denomination). Here the VN denomination may correspond to a relative rank of the valuation of the VN among all possible values, as explained with respect to S518.

At S539, the field at the LSS 252 among the dedicated physical memory space for Party #1 and starting at the field j corresponding to the variable j from S538 is read.

At S40, a determination is made whether the serial number for the VN matches with a serial number at the jth field is a match. For the first iteration of up to eight iterations in the column for 100s in FIG. 5D, this means checking to see whether the VN matches the ID of any VN stored at the 9th field in the dedicated physical memory space. The serial number may correspond to the third to eighth bytes of a VN ID, so the comparison at S540 may be a comparison of the third to eighth bytes of the VN ID and the third to eighth bytes of the corresponding field in the dedicated physical memory space.

At S541, if the VN ID matches the ID in the corresponding field of the dedicated physical memory space (S540=Yes), bit j in the third LSS field is saved as a value in a List. Insofar as the iterative processing that includes S541 will be used to transfer VNs out of the predetermined space for Party #1 in the packet if there are no errors, the List keeps track of which positions for storing VN Identifications for VNs owned by the party are to be marked vacant. The Occupied/Unoccupied third LSS field is shown in FIG. 5E.

At S542, i is decremented by 1 to check the next VN in the packet if there is a next VN in the packet.

At S543, a determination is made as to whether i=0 after the decrementing at S542. If i=0 at S543 (S542=Yes), the process moves to S551. The determination that i=0 at S543 means that all ownership checks for VNs listed in the SFIOI have passed.

At S544, if i does not=0 at S543 (S543=No), k is incremented by 8 to initiate reading of the next VN in the packet since there was a match of the current/previous VN in the packet at S540.

At S545, the VN in the packet starting at the updated byte k is read, and the process returns to S537 to check the denomination for the new VN to be checked for a match. Thus, the process from S537 through S545 is for finding a match between a VN in a packet and a VN record in the dedicated physical memory space for a party at the LSS 252. This match confirms ownership by Party #1 of the VN being checked from the packet.

At S546, if the status read at S530 is No at S531 (S531=No), the busy/not busy field is set to not busy and the processing for the packet ends. Insofar as S530 and the following processing including S546 is for a “transfer” instruction as determined at S507, the party status cannot be locked. Additionally, if the party is not clear or on a greylist, the party must be on a blacklist that prohibits transfers. Therefore, either or both of a “locked” status and/or a “blacklist” status for the party will result in the processing ending at S546 so that no responses are generated for packets and no transfers of VNs for Party #1 are allowed.

If the party is not clear or on a greylist, and/or if the dedicated physical space for the party is not unlocked (S531=No), the process ends. The process ends if Party #1 is not clear or on a greylist and/or not unlocked at S531. In this regard, a transfer as determined at S507 may not be allowed for a party that is not clear or on a greylist, which implies the party is on a blacklist. Similarly, a transfer as determined at S507 may also not be allowed for a party with a locked dedicated physical memory space.

If the VN Count checked at S532 is zero (0) (S532=Yes), the process moves to S551 insofar as the party is assumed to be transferring Change via the eighth VN field in the example SFIOI format provided herein. This also reflects that the LSS space for the party is unlocked, and the party is not on a blacklist (S531=Yes).

At S548, if there is no match for any VN being checked at S540 (S540=No), the next potential field in the dedicated physical memory space for the party at the LSS 252 is checked so j is incremented by 1, so j=j+1.

At S549, a check is made as to whether j is now equal to any of 17, 25, 33, 41, 49, 57 or 65 after the incrementing at S548, as this would indicate that the incrementing has put the value of j at the top of the next denomination such that all of the fields for the intended (previous) denomination have been checked. In other words, S549 may be considered a check for a match in the denomination column. If j is not equal to any of 17, 25, 33, 41, 49, 57 or 65 (S549=No), the method returns to S539 so that the next field in dedicated physical memory space at the LSS 252 can be checked.

If j is equal to any of 17, 25, 33, 41, 49, 57 or 65 (S528=Yes), the processing of the packet is ended because the VN being checked for ownership is not a match for any of the VNs listed in the denomination space for the party at the LSS 252. In other words, the process ends due to an ownership check failure at S549. A failure to match even a single VN in a packet is enough to justify ending processing for the packet. To end the process, byte 1 of the first LSS field for busy/not busy is made to not busy and the processing of the packet ends. When the processing of the packet is ended at any time in FIG. 5A, the busy/not busy field of the LSS for the party is marked not busy, such as by flipping a bit from 1 to 0 or from 0 to 1. The busy/not busy field may be, for example, byte 1 of the first LSS field for the party.

At S551, if I=0 at S543 (S543=Yes), the eighth VN ID field in the packet is read for Change so that a subsequent determination can check whether the change amount stated in the packet matches with the change amount on file in the second field for Party #1 at the LSS 552. For example, the Change field may be the fourteenth field of the example 128-byte SFIOI format described in this patent application family, so bytes 105 through 112. An example of the Change field is shown in FIG. 5F.

At S552, after reading the Change field in the packet at S523, one or more byte of a predetermined field of the dedicated LSS space for the party is/are compared with one or more byte of a predetermined field of the packet. For example, byte #8 of the second LSS field may be compared with byte #4 of the fourteenth packet field. The second LSS field may specify the Change amount on record for the party in byte #8, and as shown in FIG. 5F, the fourth byte of the eighth VN (i.e., the fourteenth packet field) may also specify the change amount. This determination at S552 is a slow dynamic security check insofar as the party may be required to know the amount of change they have at the LSS, and may be required to state the amount of change they have for comparison with the actual amount at S522.

At S553, if the Change comparison at S552 results in a match (S552=Yes), another predetermined field is read for the “type” of the SFIOI. For example, the fifteenth field of the packet may specify the type of the SFIOI in byte #4.

At S555, a determination is made as to whether the “type” of the SFIOI is for an ownership check. For example, an ownership check may be type “2” indicated by a value 00000010 in byte #4 of the fifteenth packet field.

At S556, if the packet is for an ownership check (S555=Yes), a response to the ownership inquiry may be initiated.

At S557, a status field to determine whether the party is on a greylist by checking one or more bytes of the Party ID field at the LSS. For example, byte #3 may be used to indicate a clear, blacklist or greylist status as values of zero (0), one (1) or two (2) respectively.

At S558, check is made as to whether the party is on a greylist. If the party is not on a greylist (S558=No), the busy/not busy field is set to not busy and the processing for the packet ends.

At S559, if the party is on a greylist (S558=Yes), a notification to be forwarded to the requester is initiated and then the busy/not busy field is set to not busy and the processing for the packet ends.

At S560, if the Change comparison at S552 does not result in a match, the busy/not busy field is set to not busy and the processing for the packet ends. The failure to match a security challenge at S553 or anywhere else in the processing may result in a substantive end to processing for the packet, though a record may be maintained as to the requester and the nature of the error, and for one or more types of errors, a notification may be sent to the requester, a law enforcement agency and/or an intermediary, depending on the nature of the error.

At S561, if the type is not an ownership check at S555 (S555=No) a determination is made as to whether the “type” of the SFIOI is for a lock by the owner. For example, a lock may be type “3” indicated by a value 00000011 in byte #4 of the fifteenth packet field. A lock may indicate that no transfers are allowed for VNs, or change owned by the party until the party unlocks their VNs by one packet, and a subsequent packet may initiate a transfer.

At S562, if the packet is for a lock (S561=Yes), a predetermined field in the LSS space for the party may be set to indicate the lock. For example, byte #4 of the first LSS field may be set to a value of “1” to indicate a lock.

At S563, if the packet is not for a lock at S561 (S561=No), a determination is made as to whether the “type” of the SFIOI is for an unlock by the owner. For example, a type of the SFIOI may be type “4” indicated by a value 00000100 in byte #4 of the fifteenth packet field. An unlock may indicate that transfers are again allowed for VNs or change owned by the party until the party locks their VNs by one packet.

At S564, if the packet is for an unlock (S563=Yes), a predetermined field in the LSS space for the party may be set to indicate the unlock. For example, byte #4 of the first LSS field may be set to a value of “0” to indicate an unlock.

At S565, after either S562 or S562, an acknowledgement to the instruction to either lock or unlock is initiated.

After S565, the process moves to S557 for the greylist checks described with respect to S557, S558 and S559.

At S569, the same operation as at S552 is performed. One or more byte of a predetermined field of the dedicated LSS space for the party is/are compared with one or more byte of a predetermined field of the packet to ensure the packet reflects knowledge of the amount of Change on record at the LSS for Party #1 listed in the packet. For example, byte #8 of the second LSS field may be compared with byte #4 of the fourteenth packet field. As shown in FIG. 5F, the fourth byte of the eighth VN (i.e., the fourteenth packet field) may also specify the change amount. The check for knowledge of the change on record for Party #1 at S569 may be the last security check before a transfer is allowed for the SFIOI.

At S570, all bits j in the third LSS field corresponding to the List generated from the iterative process at S541 are set to 0. This reflects that the VNs at the locations corresponding to the bits j for Party #1 are being transferred.

At S571, the Origin field in the packet is updated to reflect a value for internal transfers. For example, the Origin field may be at byte #8 of the fourth packet field, and the value for internal transfers may be 255 (i.e., 11111111). Updating the Origin field at S571 is performed so that when the SFIOI is put through S502 by the recipient LSS system, the recipient LSS system will process the SFIOI as an internal transfer starting at S580 rather than the main processing that starts at S503. The updating at S571 may be the only or one of the only instances of switching data for SFIOs at the register level, and this is so that the packet may be sent directly to another instance of the LSS 252 without proceeding through the SGS 256 for the other instance of the LSS 252. For example, multiple instances of the LSS 252 may be safely connected using post-quantum encryption that only enables communications between the instances of the LSS 252 for internal transfers. Dedicated hardware and separate IP addresses may be used to allow the direct internal transfers between instances of the LSS 252.

Although now shown in FIG. 5A, a node such as the IDMS 251 may be used to directly interact with different instances of the LSS 252 such as to update party ID statuses. The processing in FIG. 5A may be updated to add another value for party ID updates, such as with a value for party ID updates with a value in the Origin field of 254 (i.e., 11111110). The processing may allow for directly updating a party ID status in an LSS 252, such as to place a party on a blacklist or take a party off a blacklist. The IDMS 251 or other node may be safely connected to the instances of the LSS 252 using post-quantum encryption that only enables communications between the IDMS 251 or other node and the instances of the LSS 252.

At S572, the field for Change is read. That is, VN #8 may be used to state change in packets, and may be at the fourteenth field of the packet, so the fourteenth field may be read at S572.

At S573, the amount of Change read at S572 is subtracted from the amount of change on record for Party #1 at the LSS. For example, the amount of Change to be transferred is read from the register that stores the fourteenth field of the packet, and this amount is subtracted from the second LSS field for Party #1 in the packet. The Change is subtracted from the transferring party at S573 immediately before the VNs in the SFIOI are transferred to the receiving party starting at S574.

At S574, a response to the transfer instruction is generated. The response to the transfer instruction may be the SFIOI now routed to the destination with the dedicated physical space for Party #2. The routing may include several layers. For example, if the dedicated physical space for Party #2 is in the same unit as the dedicated physical space for Party #1 (e.g., if both have Party IDs issued by the same intermediary), then the routing will be to the queue for the same unit of the same instance of the LSS 252. If the dedicated physical space for Party #2 is in a different unit of the same instance of the LSS 252 as Party #1, (e.g., if both have Party IDs are in the same region or have the same intermediary but the intermediary is very large and has records distributed across multiple units of the LSS 252), then the routing may be back to the receiver that receives the SFIOI at S501, but now with the Origin value of 255 as updated at S571. If the dedicate physical space for Party #2 is to a different instance of the LSS 252 than Party #1, the SFIOI may be transmitted to the different instance of the LSS 252 by one of the VPN1 55202 or the VPN2 55203 shown in and explained with respect to FIG. 5G.

At S576, greylist status for Party #1 is read from the LSS space for Party #1. For example, bytes #3 and #4 may be read from the first LSS field to check whether Party #1 is on a Greylist.

At S577, a determination is made as to whether Party #1 is on a Greylist based on bytes read at S576.

At S578, if Party #1 is on a Greylist (S577=Yes), a notification is initiated and forwarded based on the determination at S577.

At S579, if Party #1 is not on a Greylist (S577=No), or if there is no match in the Change field comparison at S569 (S569=No), and otherwise after S578, the byte 1 of the first LSS field for busy/not busy is made to not busy and the processing of the packet ends.

S580 is the start of a process for secondary processing for internal transfers when a packet is received at a LSS 252 from another LSS 252. At S580, secondary processing is initiated when the packet received at S501 is from an internal transfer from another instance of an LSS in the LS 250, so 255 in the example above at the start of the description of FIG. 5A. The secondary processing is initiated based on the value of the Origin field as checked at S502.

At S581, logical address translation is performed for the Party #2 identification in the packet. VN identification are stored for parties according to party ID. Since the packet received at S501 is for an internal transfer, at S581 the VNs in the packet are to be recorded in the dedicated physical memory space for Party #2 listed in the packet as the recipient of the VNs and any specified change amount. Therefore, at S581 logical address translation is performed to look up the physical memory space for the new owner of the VNs according to the Party #2 identification. The LSS 252 may keep a lookup table or another type of logic arrangement to efficiently perform the logical address translation at S581, so party identifications and the starting physical memory address of the dedicated physical memory space for each party. The physical memory addresses may be, for example, DDR4 or DDR5 memory addresses, arranged by bank group, bank, row and column for the starting physical memory address. S581 may also involve routing to one of several units of the instance of the LSS 252 according to the Party #2 identification.

At S582, a busy/not busy field is read in the dedicated physical memory space for the Party #1 identification. For example, byte 1 of the first field of sixty four 64-bit fields in the dedicated physical memory space may be used to mark when the dedicated physical memory space is already busy. If the dedicated physical memory space is busy, a wait may be imposed until the dedicated physical memory space is not busy, such as by putting the packet back into a queue to restart the method of FIG. 5A at S501 again, or otherwise using a counter at the core performing the method of S501 to count down a predetermined number of clock cycles. If the dedicated physical memory space is not busy, then the busy/not busy field is changed to mark the dedicated physical memory space busy, such as be changing a value of the byte from 0 to 255 or another value used to mark a busy status.

At S583, the VN count in the received packet is read. For example, the VN count may be specified in the twenty eighth byte of the received packet, so the fourth byte of the fourth 8-byte field of the packet. The VN count is read to initiate a countdown as the VNs listed in the packet are stored to the dedicated physical memory space for Party #2.

At S584, a determination is made as to whether the VN count for the packet is zero, such that no VNs are listed in the packet. If the VN count is zero (S584=Yes), the process moves to S595.

At S585, if the VN count is no zero (S584=No), a variable i is set as the VN count to begin iteratively processing the VNs in the packet.

At S586, a variable k is set to a predetermined value corresponding to a byte position in the packet, and the VN is read starting at the byte position corresponding to the predetermined value to which k is now set. For example, k may be set to forty nine as the first byte of VN #1 in the packet. The forty ninth byte corresponds to the first byte of the seventh 64-bit field of the packet in this example.

At S587, the byte #2 of the VN is read to obtain the VN denomination of the VN.

At S588, a variable j is set to 1 plus 8*(the VN denomination). Here the VN denomination may correspond to a relative rank of the valuation of the VN among all possible values, so 1 for the 100s, 2 for the 50s, 3 for the 20s, 4 for the 10s, 5 for the 5s, 6 for the 2s, and 7 for the 1s. In this configuration, and as shown in FIG. 5D, the variable j may be set to 9 for a VN with a VN denomination of 100 as the highest rank among potential denominations.

At S589, a determination is made as to whether the value of the bit j in the third LSS field is zero (0). This determination checks whether the corresponding location in the dedicated memory space is empty and available to record the newly-received VN.

At S590, if the value at the location j is equal to zero (0) (S589=Yes) so that the corresponding location in the dedicated memory space is empty and available, the VN is written to the dedicated memory space at the jth field. And this is how a VN is placed in the ownership of Party #2.

At S591, the bit j in the third LSS field is set to 1 to indicate that the corresponding location in the dedicated memory space is populated.

At S592, j is incremented by 1.

At S593, i is decremented by 1.

At S594, a determination is made as to whether i is zero (0) such that all VNs in the packet have been transferred based on the VN count being run down to zero (0)

At S595, if i is zero (0) at S594 (S594=Yes, the Change field in the packet is read. In the examples herein, this means reading the fourteenth field of the packet to determine the specified Change amount.

At S596, the amount of change read at S595 is added to the second LSS field for Party #2 to add the change from the packet to the amount of change on record for Party #2.

At S597, a confirmation of receipt of the VNs and change in the packet is generated and sent to Party #2.

At S598, the status field for Party #2 is read to check whether Party #2 is on a blacklist or greylist.

At S599, a determination is made as to whether Party #2 is on a blacklist or greylist. Party #2 may be enabled to receive VNs and Change despite being on a blacklist insofar as a blacklist listing may only prevent Party #2 from transmitting VNs and change.

At S5100, if Party #2 is on a blacklist or greylist (S599=Yes), a notification is generated and sent, such as to a law enforcement agency.

If Party #2 is not on a blacklist or greylist (S599=No), or otherwise after S5100, the process of FIG. 5A ends and the busy/not busy space for Party #2 is set to not busy.

At S5101, if i does not equal zero (0) at S594 (S594=No), k is incremented by 8.

At S5102, the next VN is read from the packet starting at byte k.

At S5103, if the value of bit j in the third LSS field is not equal to zero, j is incremented by 1.

At S5104, a check is made as to whether j is now equal to any of 17, 25, 33, 41, 49, 57 or 65. If j is not equal to any one of 17, 25, 33, 41, 49, 57 or 65 (S5103=No), the process returns to S589 to again try and find an empty space for the VN in the fields of the dedicated physical memory space for Party #2.

At S5105, if j is equal to any one of 17, 25, 33, 41, 49, 57 or 65, this indicates that Party #2 may not have space in the dedicated memory space for Party #2 at the LSS. A variable m is set to 3 to check for space in overflow fields at the dedicated memory space for Party #2.

At S5106, a determination is made as to whether the value of bit m in the third LSS field is equal to zero (0). The determination that bit m equals zero (0) means that the corresponding LSS field is empty and available for the VN being transferred to Party #2

At S5107, If the value of bit m is not equal to zero (0) (S5106=No), this means that the corresponding field is populated, and m is incremented by one to check again.

At S5108, a determination is made as to whether m is equal to 9, as this would indicate that all possible overflow memory spaces of the dedicated memory space have been checked and are unavailable. If m does not equal 9 (S5108=No), the process returns to S5106.

At S5109, if m equals 9 (S5108=Yes), a process initiated to initiate a larger account for Party #2. For the purposes of FIG. 5A, the process ends after the larger account is initiated at S5109 and the VN read at S586 is stored in the larger account.

At S5110, if the value of bit m in the third LSS field equals zero (0) (S5106=Yes), the VN is written to the mth field of the LSS.

At S5111, bit m in the third LSS field is set to 1 to reflect that the mth field is populated, and the process returns to S592.

At S512, the packet received at S501 is deleted after S502 when the SFIOI Origin value is not any of the values used at the LSS 252 when checked at S502.

As set forth above, a method for managing ownership of VNs of a NDC is provided. The method comprises receiving packets from a SGS at a ledger storage device of a LSS 252 which is part of a security system for a digital asset ledger system. The ledger storage device is configured to store records of current ownership for a subset of parties that own VNs of a digital asset, and the data arrangements and network configuration are organized so that the purported current ownership of VNs listed in a SFIOI can be quickly checked. The method further includes performing ownership checks on the received packets using dedicated physical space within the ledger storage device for each party using an intermediary assigned to the LS 250, and updating current ownership information of VNs based on the ownership checks. The method incorporates safeguards against double spending by checking a busy or not busy field in the dedicated physical space before performing an ownership check, queuing the ownership check if the dedicated physical space is being used, and setting the busy or not busy field to a busy state when using the dedicated physical space and to a not busy state when usage is complete. The method efficiently handles transfers of VNs by transferring ownership within the ledger storage device when intermediaries for both parties involved in a transfer are assigned to the LSS, and transferring ownership to a different LSS when an intermediary for a recipient is assigned to the different LSS. The method leverages advanced computing technologies by using a graphics processing unit (GPU) to perform large volumes of ownership checks and other processing in parallel, and optimizing routing and lookups for incoming packets using multiple DDR blocks and matched GPUs. This approach significantly enhances the system's performance and scalability.

To maintain a comprehensive record of transactions, the method includes storing historical records for the VNs and parties using the VNs in a MMS, and backing up the historical records in a BUMS. This ensures data integrity and provides a reliable audit trail for the NDC system.

The LSS 552 is programmed to maintain and update records of VNs for parties with Party IDs issued by intermediaries assigned to the LSS 552. The programmed instance of the LSS 552 will be able to finish processing for all incoming packets, including branching for results such as based on identified types of errors or confirmation of VN ownership and correct statement of change for Party #1 and the “type” in each packet. The instance of the LSS 552 may store all current holdings in the LS 250 for parties issued Party IDs by intermediaries assigned to the LSS 552. When the safety checks for a packet are complete at the SGS 256 and the LSS 552, and the ownership checks are complete at the LSS 552, the SFIOI Type may be read to determine which type of inquiry is to be answered or which type of instruction is to be followed.

### Double Spending

The method of FIG. 5A prevents double spending by combining several features including the singular, centralized controlling aspects of a dedicated physical memory for parties, along with the busy/not busy field in the dedicated physical memory checked at S505/S582 and reset at the End of any processing. The busy/not busy field enables only one operation for the dedicated physical memory for any particular party at any one time.

### Counterfeiting

The method of FIG. 5A prevents counterfeiting by combining several features including the singular, centralized controlling aspects of a dedicated physical memory for parties, along with performance of proactive ownership confirmations for SFIOIs that get through the SGS 256 and that contain VN IDs for VNs (as compared to only for change in VN #8 ID). The proactive ownership confirmations are for SFIOIs that include transfer instructions and for SFIOIs that are for other types of instructions. The proactive ownership confirmations are performed from S512 through ending after S528 for types other than transfers, and S532 through S551 for transfers.

FIG. 5B illustrates a party ID field at an LSS.

The party ID field at an LSS 252 differs in important ways from a party ID field in a packet. In the dedicated physical space for a party shown as the “User ID” in FIG. 5D, the party ID is used for several functions specific to the LSS 252. A Busy or Not Busy field in the first byte of the User ID field is used to prevent double spending. Any time a core of a multicore or GPU is tasked with checking the dedicated physical space for a party, the core checks the Busy or Not Busy field. If the dedicated physical space is busy and being used by another core, the core performing the check will return the packet to a queue so as to impose a delay of a fraction of a second. If the dedicated physical space is not busy, the core performing the check will write a busy value to the Busy or Not Busy field, and then write a not busy value when all processing by the core performing the check is complete. The second byte of the party ID field is blank in the example party ID field shown in FIG. 5B. A third byte is used to specify a status of the party. The normal status will be clear, but a blacklist status will result in no ability to perform some or all types of operations including transfers of VNs away from the party. A greylist status may allow for some or all types of operations but may require one or more notifications such as to law enforcement. The fourth byte is a locked/unlocked field, and this field allows parties to lock their VNs until the parties unlock their VNs. A variety of procedures may be enabled for a party to unlock their locked VNs, including multifactor authentication or just sending a packet dedicated only to unlocking the dedicated physical space for the party. The last four bytes of the party ID field are the individual ID for the party, and this should match the individual ID for Party #1 in a packet in most cases except for when a packet is being used for an internal transfer in the LS 250 and the individual ID for Party #2 is used to specify the dedicated physical space for where the VNs listed in the packet are to be recorded. The intermediary ID is not required in the party ID field since the dedicated physical space is part of a larger dedicated physical space for the intermediary for the party.

The User ID in the format of FIG. 5D is shown in FIG. 5B, and is a modification of the Party ID in packets. The User ID enables several safety measures including an ability to thwart double spending and a blacklist/greylist countermeasure. The operations using the User ID field ensure the centralized, singular and real-time ownership of VNs maintained at the LSS 552 for the party corresponding to the User ID can only be updated based on one packet at a time. The ownership check implemented for each error-free packet that reaches the LSS 552 (i.e., regardless of “type”) ensures ownership of the VN by the party corresponding to the User ID before any transfer is allowed. A “busy” is likely to be rare for any party given how fast processing is at the SGS 256 and LSS 552. However, the risk of memory access conflicts and double spending must be addressed by the LS 250 from the beginning, no matter how rarely it is expected. Additionally, the arrangement of data at the LSS 552 for a party is also how to implement blacklist/greylist functionality. The blacklist status in the third byte of the User ID is checked second at the LSS 552, as blacklist will mean that some or all activity is not allowed for the party corresponding to the User ID. In some embodiments, a blacklisted party may be able to receive VNs but blocked from transmitting VNs. The LS 250 has no choice but to enable this functionality to comply with court orders or other legal mandates under existing laws. Greylist is also checked here, and if active, may be used to generate a record for the activity as a notification such as to a law enforcement agency monitoring the party pursuant to a warrant.

FIG. 5C illustrates example VN placements in an example format for a SFIOI.

The VN placements in the current SFIOI format being used include eight of sixteen 64-bit fields. The VN placements include seven VN ID fields for VNs, and one VN ID field (the VN ID #8 field) for change. The current VN placements are at the seventh through fourteenth of the sixteenth fields of the current SFIOI format.

FIG. 5D illustrates an example layout for space dedicated to a party at an LSS.

The example layout in FIG. 5D shows eight columns of eight fields, but in practice this arrangement of data is much more likely to involve part of a single DDR row or the end of one DDR row and the beginning of the next DDR row. The sixty four total fields include a first field for the User ID/party ID in FIG. 5B, a second field for the current amount of change at the LSS 252 for the party, and a third field for the occupied/unoccupied data used to combat double spending. The next five fields are extra, and may be off-limits entirely, used for overflow VNs transferred to the party ID, or reserved for future higher denominations than currently allowed by the issuer of VNs. The next seven sets of eight fields are each dedicated to the seven different denominations currently used in the United States.

To be sure, the arrangements of fields in the layout of FIG. 5D may be different than shown. Some denominations may have fewer available fields than others for example. Additionally, the default size of the space for a party may be less than or greater than sixty four fields, and larger sizes of space may be allocated in advance and/or dynamically for parties who require more than the default size.

The default amount of memory reserved for any particular party in FIG. 5D is 512 bytes in this arrangement. This would allow a single 512 Gigabyte DDR5 memory which can be provided in a single memory package to provide the default space for records for over 1 billion parties, so enough for every citizen of the United States. Nevertheless, multiple instances of the LSS 552 may be distributed around in the LS 250, and each LSS 552 may include multiple units. The arrangement of the memory allows minimization of real-time packet processing operations at each LSS 552 and duplication for backups. Additionally, some units of DDR at an instantiation of the LSS 552 may be provided for parties who require more than 512 bytes of memory. For example, some parties may be provided 2048 bytes of memory, others may be provided 4096 bytes of memory, and others may be provided 8192 bytes of memory. In this way, entities with large volumes of cash handling requirements are readily accommodated. Additionally, the system may be configured to re-assign a user ID if a party unexpectedly requires more memory at a LSS 552 than currently allocated, such as a student graduating from college and receiving many VNs as graduation gifts.

The LS 250 may be used for purposes other than denominated and serialized VNs of a national digital currency. For example, five “extra” spaces are shown in FIG. 5D in the first column. These five “extra” spaces may be dedicated to accounts such as savings and checking accounts. For example, the fourth line in the first column may be dedicated to checking accounts, the fifth line in the first column may be dedicated to savings accounts, the sixth line in the first column may be dedicated to one-time stimulus payments, the seventh line in the first column may be dedicated to tax refunds, and so on. These type of accounts are different than the primary purpose of the LSS 252 and the overall teachings herein, which is to enable the LS 250 to safely interface with the worldwide population while tracking serialized and denominated VNs of a national digital currency.

Additionally, some or all of the teachings herein may be used for purposes entirely different than digital currencies. For example, a state secretary of state (SOS) my use teachings herein to manage vehicle registrations for parties insofar as vehicle identification numbers (VINs) and plate identifications (IDs) should fit into one or more 64-bit fields such as those used in the LSS 252. Other uses for the teachings herein include for property ownership such as real property records. To be sure, none of these alternative uses would face anything close to the demands for a national digital currency with serialized and denominated VNs of a national digital currency. Nevertheless, to the extent that the extreme use case of a national digital currency requires new solutions such as those described herein, the new solutions will be applicable to other use cases.

FIG. 5E illustrates an example occupied/unoccupied field at an LSS.

The third field marked occ/un (for occupied/unoccupied) in FIG. 5D shows whether each of the 61 other fields are occupied or vacant as VNs move in and out of a party's ownership, so that status of the corresponding bit of the 64 total bits in the third field is flipped to 0 when a VN in an occupied field is transferred away from the party and is flipped to 1 when a VN is transferred in to a vacant field. These 64 occupied/vacant status bits for the third field appear as shown in FIG. 5E when all 61 occupiable VN fields are occupied. As shown, the sixty four bits of the occupied/unoccupied field #3 of the space dedicated to a party at an LSS are used to show when any of the fourth through sixty fourth fields are populated with a VN ID for a VN owned by the party. When a VN is transferred away from the party, the bit for the VN is flipped back to unoccupied, and when a VN is transferred in, the core of the GPU or multicore performing the processing finds the first unoccupied field for the denomination of the VN and then marks the corresponding bit occupied and writes the VN ID in the first unoccupied field to make the first unoccupied field occupied.

FIG. 5F illustrates a change field for VN #8 in an SFIOI.

The change field in FIG. 5F includes a source ID that identifies an issuer of the change, a denomination which is used to show that the field is for change, a change amount for when a packet is a transfer, and a change amount to match against the second field of the dedicated physical space for the party at the LSS as a security measure. The last four bytes are the individual ID for the party, and should match the individual ID in the LSS Party ID/User ID field #1 in the dedicated physical space for the party.

FIG. 5G illustrates a circuit arrangement for an LSS.

The LSS 552 in FIG. 5G includes a GPU/MC 55210, a memory 55220, a memory controller 55225, a bus 55208, a power source 55207, a receiver 55205, a transmitter 55295, a VPN1 55202, a VPN2 55205, and an SGS line 55201. The LSS 552 may include more elements than those shown or described. Notably, the receiver 55205 and the transmitter 55295 may be literal receivers and transmitters and not transceivers, in that the reception activities of the LSS 552 may be made safe by ensuring the receiver 55205 is not used to transmit, and in that the transmit activities of the LSS 552 may be made safe by ensuring that the transmitter 55295 is not used to receive. Additionally, the memory 55220 may comprise a plurality of instances of a DDR memory and the GPU/MC 55210 may comprise a plurality of instances of processors, such that the LSS 552 may comprise a plurality of processors and matched DDR memories to optimize routing and lookups for incoming packets.

The GPU/MC 55210 is a graphical processing unit or multi-core processor. Each core of the GPU/MC 55210 is configured to perform the features of FIG. 5A attributable to the GPU/MC 55210. Using the GPU/MC 55210, the programmed instance of the LSS 552 may be built as an ASIC unit capable of maintaining and updating records of VN ownership in real-time. The LSS 552 may be paired with a programmed SGS 556 as an ASIC unit able to process at least 240,000 packets per core per second and the programmed instance of the LSS 552 as an ASIC unit may be able to process at least 4000 packets per core per second and update the LSS 552 records when appropriate. As a processor, the GPU/MC 55210 is configured to initiate transfer of ownership of VNs within the LSS 252 when intermediaries for both parties involved in a transfer are assigned to the LSS 252. The GPU/MC 55210 is also configured to initiate transfer of ownership of VNs to a different instance of the LSS 252 when an intermediary for a recipient is assigned to the different ledger storage system. These features are present in the method of FIG. 5A.

The memory 55220 may be a DDR4 or DDR5 block or a suitable alternative. The memory 55220 is the memory that provides the dedicated physical space for parties. For example, the memory 55220 may be dedicated to one or more than one intermediary service provider so that the records for the customers of the one or more intermediary service provider are stored in the memory 55220. For example, the memory 55220 may store records for 5 million, 10 million, or 20 million parties.

The memory controller 55225 may be independent or may be integrated with or part of the GPU/MC 55210 or memory 55220. The memory controller 55225 is responsible for the minimal virtualization in the LSS 552, and that is translating party IDs into physical memory addresses of the dedicated physical memory for parties. Virtualization is a key weakness anywhere in the LS 250, as this requires reliance on a third-party logical mechanism such as a memory controller until the provider of the LS 250 can design and implement such a memory controller. The need to rely on mild virtualization/abstraction performed by memory controllers for logical address translation is essentially necessary for now, as it is not feasible for NCT to track physical memory addresses at the SGS 256 and LSS 552 insofar as physical memory addresses wear out from use over time, and tracking which physical memory is usable and used is a function performed by memory controllers. This requires NCT to “trust” hardware for this type of virtualized/abstracted task. This risk is alleviated partially by using DDRs or similar byte-addressable memory for the SGS 256 and LSS 552 with multiples of the memory space required for even 10,000,000 parties. Given the choice between arranging the LSS 552 by Party ID or by VNs, it becomes apparent that organizing by Party ID is greatly preferable. The alternative of organizing by VNs would require that packet data received at the LSS 552 be held in place while pulling data from up to seven different memory locations for up to seven different VNs. Organizing by Party ID becomes much easier insofar as all checks for the packet data can be made using the records for the Party ID. In FIGS. 5D, 64 64-bit fields of memory are provided for a party corresponding to the User ID at the upper left. The first 8 fields in the first column are for the Party #1, for the Change belonging to Party #1 in the LSS 552, occupied/vacant status of the other 61 fields, and for five VNs of a potential future denomination such as $500s, $1000s, $5000s, $10000s, and $20000s. As an example, higher denominations may be made available in a LS 250 for a NDC without being made available as physical cash. The next sets of 8 fields are arranged by the remaining, current, seven denominations for bills of physical United States currency, i.e., by 100s, 50s, 20s, 10s, 5s, 2s and 1s. To be sure, in a DDR memory used in the LSS 552, all 64 64-bit fields are likely to be provided together in a single row in a single bank of a bank group. A single DDR4 row has space for 1024 such fields, so enough to store records for 16 different parties using the 64 64-bit fields (columns) in the illustration above. The 64 fields may be allocated to parties such as when an intermediary assigns Party IDs to customers. By knowing the denomination for a VN, the number of fields to check at the LSS 552 is limited to the eight (8) fields reserved for any particular denomination, rather than requiring checking all of the 61 available fields.

VPN1 55202 may be a dedicated permanent VPN connection with a first other LSS. VPN2 55203 may be a dedicated permanent VPN connection with a second other LSS. Three different SGS/LSS pairs are shown in FIG. 7. To the extent that VNs may be transferred between parties assigned to different LSSs, VPN1 55202 and VPN1 55203 are representative of dedicated connections between LSSs.

SGS line 55201 is a hard connection between the LSS 552 and its paired SGS. The connection between the LSS 552 and its paired SGS may be one-way, such that the paired SGS sends packets to the LSS 552, but there is no transmission from the LSS 552 to the paired SGS.

The bus 55208 is representative of one or more connections between the other elements of the LSS 552.

Power source 55207 may be a battery or an interface to a dedicated power source for the LSS 552.

Referring to FIG. 5G, the LSS 252 may include random access memory (RAM) as the memory 55220 and a 16-core multicore processor as the GPU/MC 55210. Alternatively, the GPU/MC 55210 may comprise a GPU with thousands of cores. In the context of the LSS 552, RAM serves as a storage area for data related to the ownership of VNs for functions performed based on the types of packets being processed by the GPU/MC 55210. RAM as the memory 55220 provides the GPU/MC 55210 with quick access to this data, enabling the cores to perform functions efficiently.

The cores of the GPU/MC 55210 are a type of processor that can execute instructions independently of the others. The cores may operate simultaneously on different packets received from the SGS 256. This parallelism is particularly beneficial in the context of the LSS, where large volumes of ownership checks and other processing tasks need to be performed simultaneously on a continuous basis. The memory 55220 is capable of maintaining records for large numbers of parties, such as 10 or 20 million parties using identifications assigned by one or several intermediaries assigned to the LSS that includes the corresponding GPU/MC 55210.

A single instance of the LSS 552 may include multiple DDR blocks as the memory 552210 and matched GPUs or multicores. The use of multiple pairs of memory and GPUs or multicores enables optimized routing for scalability and speed. This configuration allows the LSS 552 to handle a high volume of transactions and ownership checks efficiently and effectively.

In an alternative embodiment, a multicore processor may include a different number of cores, such as 8, 32, or 64 cores. The specific number of cores may vary based on the processing requirements of the LSS. Similarly, the size of the DDR may be adjusted depending on the amount of data that needs to be stored for the intermediaries assigned to the LSS 552.

In another alternative embodiment, the GPU/MC 55210 may include additional components, such as a cache memory for storing frequently accessed data, and the memory controller 55225 as an internal element for managing data transfers between the memory 55220 and the GPU/MC 55210. In this configuration, these additional components may further enhance the performance and efficiency of the LSS 552.

Accordingly, the GPU/MC 55210 provides a highly efficient and effective solution for managing ownership of VNs of a NDC in an LSS 552. The ability to perform large volumes of ownership checks and other processing tasks in parallel, combined with capacity to handle a high volume of transactions, makes it well suited to the demands of an NDC system.

As set forth above, an LSS 552 is provided for storing ownership of VNs of an NDC in a LS 250 for the NDC. The LSS 552 is configured to store current ownership information of VNs in dedicated physical memory space within the memory 55220 for each of a plurality of parties using an intermediary assigned to the LSS 552. The dedicated physical space includes predetermined amounts of memory for different denominations of the NDC that can be owned by parties. The GPU/MC 55210 is configured to perform ownership checks for VNs listed in packets received at the LSS 552 according to purported owners listed in the packets as party identifications issued to the purported owners by the intermediaries assigned to the LSS 552. In a specific configuration, a default predetermined amount of memory comprises 64 64-bit fields, with 8 fields for each of 7 different denominations. This structure allows for efficient storage and retrieval of ownership information such as VN IDs for various denominations of the NDC. The LSS 552 provides flexibility in memory allocation by offering a larger dedicated physical space provided in advance for parties that may need more space. This feature accommodates parties with higher transaction volumes or larger holdings of VNs. To address unexpected increases in VN ownership, the LSS 552 also incorporates a dynamic allocation system. This system is configured to allocate larger dedicated physical space in real-time when a party receives large amounts of denominated VNs unexpectedly, such as for graduating from high school or college. The GPU/MC 55210 of the LSS 552 can transfer ownership of denominated VNs within the LSS 552 when intermediaries for both parties involved in a transfer are assigned to the LSS 552. This allows for fast, internal transfers without the need for external processing. In cases where the recipient's intermediary is assigned to a different LSS 552, the GPU/MC 55210 is configured to transfer ownership of denominated VNs to that different instance of the LSS 552. This feature ensures seamless transactions across different regions or jurisdictions within the NDC network. To counter double spending, the LSS 552 incorporates a busy or not busy field in the dedicated physical space. This feature allows for real-time tracking of ownership check processes and prevents simultaneous conflicting transactions. The GPU/MC 55210 is configured to implement a robust protocol for handling ownership checks including checking the busy or not busy field for a party when starting an ownership check, queuing the ownership check if the predetermined physical space is being used, and setting the busy or not busy field to a busy state when using the predetermined physical space and to a not busy state when usage is complete. A single DDR block as the memory 55220 and corresponding GPU as the GPU/MC 55210 may be configured to maintain records for at least 10 million parties.

FIG. 5H illustrates a party ID field in the SFIOI format as compared to at the LSS.

A format for the Party IDs in the SFIOI format is 8 bytes (64 bits). The source ID is a byte representing the nation for the party, with 187 assigned to the United States. The intermediary ID is three bytes including two bytes representing the intermediary that issues the Party ID (10000 is used by NCT as a testing intermediary ID), and one byte for large intermediaries that may require more than one intermediary ID for efficient processing at the LSS 252. The Individual ID is four bytes representing the individual ID issued for the party by the intermediary. To be sure, four bytes provides more than 4 billion variations, so more than enough to represent all the customers of any particular bank or similar entity.

A pseudocode text flow similar to the flow in FIG. 4B but with some variations at a more detailed level in some respects is provided next.
Register starting values:
Register 1=Physical starting RAM row address, so row 1, then successors
Register 2—Empty, used to temporarily store VN Count and Origin retrieved from SFIOI at
Word 4, then update VN Count quickly to VN Count+4 as RegistertoCheckValue.
Register 3—Empty, used to temporarily store First Party ID retrieved from SFIOI at Word 5.
Register 4—Empty, used to temporarily store Second Party ID retrieved from SFIOI at Word 6.
Register 5—Empty, used to temporarily store VN #1 ID retrieved from SFIOI at Word 7.
Register 6—Empty, used to temporarily store VN #2 ID retrieved from SFIOI at Word 8.
Register 7—Empty, used to temporarily store VN #3 ID retrieved from SFIOI at Word 9.
Register 8—Empty, used to temporarily store VN #4 ID retrieved from SFIOI at Word 10.
Register 9—Empty, used to temporarily store VN #5 ID retrieved from SFIOI at Word 11.
Register 10—Empty, used to temporarily store VN #6 ID retrieved from SFIOI at Word 12.
Register 11—Empty, used to temporarily store VN #7 ID retrieved from SFIOI at Word 13.
Register 12—Empty, used to temporarily store VN #8 ID retrieved from SFIOI at Word 14.
Register 13—Empty, used to temporarily store SFIOI type and Intermediary ID at Word 15.
Register 14—Empty for tracking statuses at the SGS 156 and the LSS 152.
Activate
Read RAM row address in Register #1
Move (Read/Sense) VN Count and Origin from RAM row address, Word #4 into Register #2
Set RegistertoCheckValue=VN Count+5 in Register #2
Move (Read/Sense) First Party ID from RAM row address, Word #5 into Register #3
Move (Read/Sense) Second Party ID from RAM row address, Word #6 into Register #4
Move (Read/Sense) VN #1 ID from RAM row address, Word #7 into Register #5
Move (Read/Sense) VN #2 ID from RAM row address, Word #8 into Register #6
Move (Read/Sense) VN #3 ID from RAM row address, Word #9 into Register #7
Move (Read/Sense) VN #4 ID from RAM row address, Word #10 into Register #8
Move (Read/Sense) VN #5 ID from RAM row address, Word #11 into Register #9
Move (Read/Sense) VN #6 ID from RAM row address, Word #12 into Register #10
Move (Read/Sense) VN #7 ID from RAM row address, Word #13 into Register #11
Move (Read/Sense) VN #8 ID from RAM row address, Word #14 into Register #12
   If RegistertoCheckValue=5 (i.e., VN Count=1), Compare Register #6 with 0
   a. if Register #6=0, jump to 17
   b. else, set Register 14 to 2 as error status and jump to 18
   If RegistertoCheckValue=6 (i.e., VN Count=2), Compare Register #7 with 0
   c. if Register #7=0, jump to 17
   d. else, set Register 14 to 2 as error status and jump to 18
   If RegistertoCheckValue=7 (i.e., VN Count=3), Compare Register #8 with 0
   e. if Register #8=0, jump to 17
   f. else, set Register 14 to 2 as error status and jump to 18
   If RegistertoCheckValue=8 (i.e., VN Count=4), Compare Register #9 with 0
   g. if Register #9=0, jump to 17
   h. else, set Register 14 to 2 as error status and jump to 18
   If RegistertoCheckValue=9 (i.e., VN Count=5), Compare Register #10 with 0
   i. if Register #10=0, jump to 17
   j. else, set Register 14 to 2 as error status and jump to 18
   If RegistertoCheckValue=10 (i.e., VN Count=6), Compare Register #11 with 0
   k. if Register #11=0, jump to 17
   l. else, set Register 14 to 2 as error status and jump to 18
   If RegistertoCheckValue=11 (i.e., VN Count=7 (effective maximum), jump to 17
   Else, set Register 14 to 2 and jump to 18
   Compare Register #2 first byte to 187
   a. if Register #2 first byte=187, jump to 18
   b. else, set Register #14 to 1 as error status, and jump to 18
   Output/Send First Party ID from Register #3, Second Party ID from Register #4, VN ID(s) from Register #5 through Register #12, SFIOI Type and Intermediary ID from Register #13, and Tracking Status from Register #14
   Increment RAM row address in Register #1
   RAM count value>40000?
   a. If yes, Jump to 21
   b. If no, jump to 2
   Reset Register 1 to row 1
   Stop

As an explanation for the flow above, the row address may be set by or retrieved from a memory controller as a physical address in DDR4 or DDR5, and then used to read the VN Count and Origin, First Party ID, Second Party ID, all eight VN #fields, the SFIOI Type and Intermediary ID at predetermined relative locations such as offset columns in the row at the row address. The first check is for VN count, as the register value at the register numbered VN count +5 should be empty (all zeros (0s)) unless all seven VN #fields are purportedly populated in which case this check is moot. An error here corresponds to error type #2. Notably, in this example, seven VN fields may be populated with VN IDs and the eighth VN field is for change. The second check is a status check at 17 for whether the Origin in Register #2 is equal to 187 for the United States, and an error here corresponds to error type #1. Once these check are performed, the SFIOI data is output now from the registers for the core performing the algorithm for the ownership checks at the LSS 252. The actual assembly code that is run to perform this flow may vary the use of registers and so on, but this is as reasonably close as NCT can get to writing out a register-level flow for two basic security checks performed by an algorithm at the SGS 256. This flow stops when the RAM count value is above 40000, though in testing up to 1,000,000 purported SFIOIs were tested during the project. The use of a single algorithm for any particular SFIOI avoids any potential for conflicts.

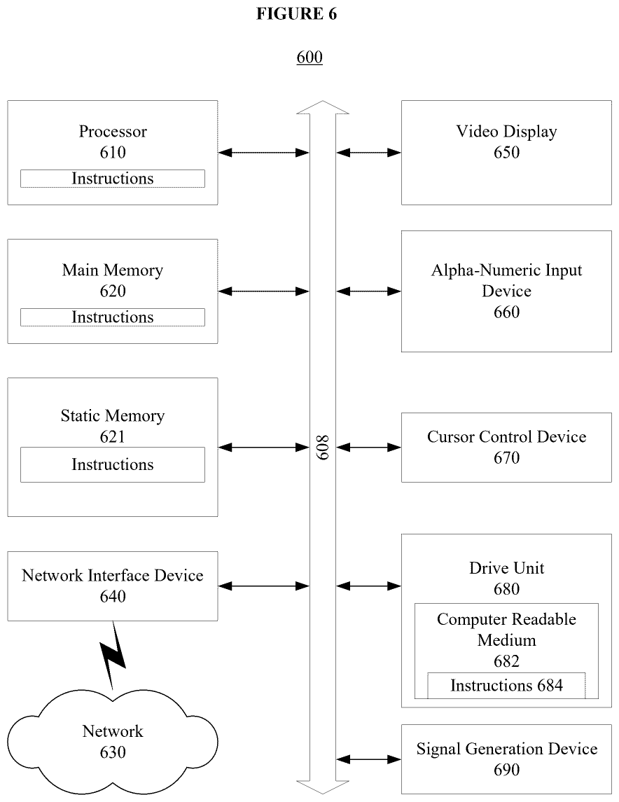

FIG. 6 illustrates a computer system, on which a method for implementation mechanisms for digital currencies is implemented, in accordance with another representative embodiment.

Referring to FIG. 6, the computer system 600 includes a set of software instructions that can be executed to cause the computer system 600 to perform any of the methods or computer-based functions disclosed herein. The computer system 600 may operate as a standalone device or may be connected, for example, using a network 601, to other computer systems or peripheral devices. In embodiments, a computer system 600 performs logical processing based on digital signals received via an analog-to-digital converter. The computer system 600 is representative of a system that can be used to implement the SGS 256, the LSS 252 and/or other elements of the LS 250, though such elements may have more, fewer and/or different elements than shown in FIG. 6, such as the elements being developed as ASICs now by NCT.

In a networked deployment, the computer system 600 may operate in the capacity of a server or as a client user computer in a server-client user network environment, or as a peer computer system in a peer-to-peer (or distributed) network environment. The computer system 600 can also be implemented as or incorporated into various devices or systems, such as an ES, a SGS, an LSS, ISPs, MFA system(s), a workstation, a stationary computer, a mobile computer, a personal computer (PC), a laptop computer, a tablet computer, or any other machine capable of executing a set of software instructions (sequential or otherwise) that specify actions to be taken by that machine. The computer system 600 can be incorporated as or in a device that in turn is in an integrated system that includes additional devices. In an embodiment, the computer system 600 can be implemented using electronic devices that provide voice, video or data communication. Further, while the computer system 600 is illustrated in the singular, the term “system” shall also be taken to include any collection of systems or sub-systems that individually or jointly execute a set, or multiple sets, of software instructions to perform one or more computer functions.

As illustrated in FIG. 6, the computer system 600 includes a processor 610. The processor 610 may be considered a representative example of a processor of a controller and executes instructions to implement some or all aspects of methods and processes described herein. The processor 610 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 610 is an article of manufacture and/or a machine component. The processor 610 is configured to execute software instructions to perform functions as described in the various embodiments herein. The processor 610 may be a general-purpose processor or may be part of an application specific integrated circuit (ASIC). The processor 610 may also be a microprocessor, a microcomputer, a processor chip, a controller, a microcontroller, a digital signal processor (DSP), a state machine, or a programmable logic device. The processor 610 may also be a logical circuit, including a programmable gate array (PGA), such as a field programmable gate array (FPGA), or another type of circuit that includes discrete gate and/or transistor logic. The processor 610 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 600 further includes a main memory 620 and a static memory 630, where memories in the computer system 600 communicate with each other and the processor 610 via a bus 608. Either or both of the main memory 620 and the static memory 630 may be considered representative examples of a memory of a controller, and store instructions used to implement some, or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 620 and the static memory 630 are articles of manufacture and/or machine components. The main memory 620 and the static memory 630 are computer-readable mediums from which data and executable software instructions can be read by a computer (e.g., the processor 610). Each of the main memory 620 and the static memory 630 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 600 further includes a video display unit 650, such as a liquid crystal display (LCD), an organic light emitting diode (OLED), a flat panel display, a solid-state display, or a cathode ray tube (CRT), for example. Additionally, the computer system 600 includes an input device 660 such as an alpha-numeric input device such as a keyboard/virtual keyboard or touch-sensitive input screen or speech input with speech recognition, and a cursor control device 670, such as a mouse or touch-sensitive input screen or pad. The computer system 600 also optionally includes a disk drive unit 680, a signal generation device 690, such as a speaker or remote control, and/or a network interface device 640.

In an embodiment, as depicted in FIG. 6, the disk drive unit 680 includes a computer-readable medium 682 in which one or more sets of software instructions 684 (software) are embedded. The sets of software instructions 684 are read from the computer-readable medium 682 to be executed by the processor 610. Further, the software instructions 684, when executed by the processor 610, perform one or more steps of the methods and processes as described herein. In an embodiment, the software instructions 684 reside all or in part within the main memory 620, the static memory 630 and/or the processor 610 during execution by the computer system 600. Further, the computer-readable medium 682 may include software instructions 684 or receive and execute software instructions 684 responsive to a propagated signal, so that a device connected to a network 601 communicates voice, video or data over the network 601. The software instructions 684 may be transmitted or received over the network 601 via the network interface device 640.

FIG. 7 illustrates a partial system layout for a SGS, in accordance with a representative embodiment. Specifically, FIG. 7 illustrates a distribution of paired SGSs and LSSs for an LS.

As shown, instances of the SGS 256 are paired with instances of the LSS 252 in FIG. 7. A first paired instance is the SGS 256A and LSS 252A. A second paired instance is the SGS 256B and LSS 252B. A third paired instance is the SGS 256C and LSS 252C. For example, instances of the SGS 256 may be provided on the West Coast of the United states, in the Midwest of the United States, and on the East Coast of the United States, as well as possibly in more places. In regions with several small nations, for example, a single paired instance of the SGS 256 and LSS 252 may serve multiple nations. Communications between any paired instance of the SGS 256 and LSS 252 and any other elements in the LS 250 may be provided over a private communications network with dedicated private communication lines and/or via semi-permanent or permanent encrypted communication links using the public internet, such as via virtual private network (VPN) or similar connections. Accordingly, multiple SGSs and LSSs may be provided for an LS for implementing a digital currency or other digital asset. As should be clear, some facilities in the LS 250 may include enormous amounts of electronic equipment including servers, memory, communications lines, high-end routers and more.

-Current ownership of instances of VNs can be maintained for different parties in different places, such as by grouping intermediaries by type and/or by geography. This is made possible by the SFIOI format so that, for example, East coast banks can have the records of current ownership of a digital currency for their customers maintained at a first instance of the LSS 552, and northern banks can have the records of current ownership of the digital currency for their customers maintained at a second instance of the LSS 552. When VNs of the digital currency are transferred between parties with Party IDs issued by intermediaries in different groupings, the current ownership of the VNs is transferred between the different instances of the LSS 552.

Because the ramifications of the concept of multiple instances of a SGS 256 and a LSS 552 may be difficult to grasp, the concept can be explained another way. Because responsibility for intermediaries can be separated using multiple LSS 552 instances, this is analogous in some ways to providing temporary regional digital currencies. Records for the real-time ownership for customers of intermediaries assigned to one instance are stored at that instance, and records of the real-time ownership for customers of intermediaries assigned to another instance are stored at the other instance. VNs can be transferred between owners assigned to different LSS 552s, in which case the LSS 552 for the new owner is notified to update the records of the new owner by the LSS 552 for the old owner. This type of transfer is explained with respect to the method of FIG. 5A.

The embodiments of the teachings disclosed herein are intended to be illustrative and not limiting. Other embodiments are possible, and modifications may be made to the embodiments without departing from the spirit and scope of the invention. As such, these embodiments are only illustrative of the inventive concepts contained herein.

As should be clear, a variety of teachings herein may be implemented without implementing all of the teachings herein. The same is true of a variety of teachings in this and other patent filings by National Currency Technologies, Inc.

-Given the teachings set forth above, the economic competitiveness of the United States or another nation or region may be improved by ensuring that a digital version of a physical currency remains trusted and trustworthy and by providing more efficient commerce and large reductions in fees imposed on consumers. The SGS 256 and LSS 552 also help reach a balance of safety, inclusivity, openness and relative privacy. While national digital currencies will be disruptive, they may also overall advance the health and welfare of the public by reducing financial stress, providing a safer and fairer society, and helping combat existing incentives to for cartels to pour dangerous drugs into nations and regions. By providing a safe way to transact national digital currencies in real time, the SGS 256 and LSS 552 greatly reduces commercial friction at the retail level such as check settlement times and fees such as ATM fees, wire transfer fees, and credit card swipe fees. The SGS 256 and LSS 552 help support national and regional defenses by providing mechanisms to combat money laundering, terror financing, counterfeiting and other types of fraud. As such, the only opponents to a national digital currency implemented in this way should be terrorist groups, drug cartels and other types of criminal groups, and otherwise incumbent entities who stand to lose monopolistic commercial advantages in a safer and fairer society resulting from the disruptive technologies described herein. Criminal conduct enabled by the absence of a ledger system for physical fiat currency enables a variety of harmful conduct including money-laundering, terrorism financing, counterfeiting and other types of fraud. The ledger system described herein addresses such harmful conduct. The ledger system also enables reaching a balance of inclusivity and security, wherein a ledger system for a national digital currency can interface with the worldwide public. Safety for a government in this context means that the ledger system must be able to safely accept communications from the worldwide public without the government being forced to trust any particular intermediary. The ledger system and the SFIOI format described herein ensure maximal inclusivity and safety by defining the only data accepted by the ledger system without limiting communications to one or a small set of intermediaries.

The LSS 552 described herein quickly and efficiently performs a secondary set of security features for SFIOIs that pass processing at the SGS 256. The Party ID includes an intermediary ID for the intermediary that issues the Party ID. The LSS 552 and SGS 256 may be instantiated in multiple instances, so that each LSS 252 can be responsible for storing VN ownership records for Party IDs issued by a subset of the intermediaries. In this way, the ledger system is a hybrid that is both centralized and distributed, but is not a distributed ledger in that the ledger system is not a consensus network. As VNs are transferred between Party IDs issued by different intermediaries, current ownership of the VNs is transferred between the different instances of the LSS 552. The LSS 552 may be implemented using multi-cores or GPUs to optimize throughput and minimize networking requirements. The ledger system described herein does not require an issuer to trust any particular intermediary. And the SFIOIs are provided to the SGS 256 unencrypted via intermediaries, so that the intermediaries are responsible for security features such as encryption up to the SGS 256 but not into the SGS 256. SFIOIs can be encrypted during transit over intermediary channels, but governments are not responsible for decryption.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Although implementation mechanisms for digital currencies has been described with respect to VNs, the teachings herein are not limited in applicability to VNs or any particular NDC authorized by a government or issued by or on behalf of a central bank. Rather, various aspects of the teachings herein may be implemented for other forms digital currencies including stablecoins and other forms of cryptocurrencies, as well as other forms of digital tokens that are used as mediums of value, including digital currencies that do not share one or more characteristics of VNs as described herein.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A security system for a digital asset ledger, comprising:
a security gateway that interfaces with the public over the internet, that comprises a memory that stores a plurality of algorithms and a plurality of cores that respectively execute the plurality of algorithms in parallel to process packets received over the internet, wherein the packets are required to conform to a format that specifies requirements for fields at predetermined relative locations of payloads of acceptable packets, and each algorithm processes packets by implementing a plurality of safety checks by checking data in the fields at the predetermined relative locations of the payloads of the packets for compliance with the format until the plurality of safety checks are passed or until any safety check is not passed.

2. The security system for the digital asset ledger of claim 1, wherein the plurality of algorithms are configured to update a first specified field at a first predetermined relative location of the payloads of the packets when any safety check is not passed by populating the first specified field with a value corresponding to the safety check that is not passed.

3. The security system for the digital asset ledger of claim 2, further comprising:
a ledger storage system that stores records of current ownership of instances of a tracked digital asset, and that performs ownership checks by confirming whether ownership listed in each packet that passes processing by the plurality of algorithms at the security gateway is correct for at least one tracked digital asset listed in the packet, wherein the ledger storage system is configured to initiate disposition of packets according to a second specified field at a second predetermined relative location of the payloads of packets that pass all of the plurality of safety checks at the security gateway and the ownership checks at the ledger storage system, wherein the ledger storage system is configured to proactively confirm ownership of the instances of the tracked digital asset listed in the acceptable packets without transferring ownership of the instances of the tracked digital asset listed in the acceptable packets as a disposition among a plurality of possible dispositions according to a value in the second specified field at the second predetermined relative location.

4. The security system for the digital asset ledger of claim 1, wherein the memory comprises:
addressable memory for storing the packets received from the public, and
sets of registers dedicated to corresponding cores and used for operations when processing the packets; and
wherein the digital asset ledger further comprises:
a main memory system that is physically remote from the security gateway and that is shielded from the public by the security gateway by being inaccessible to the public over the internet at any internet protocol address, that stores historical records of all instances of a tracked digital asset for the digital asset ledger, and that receives updates to the historical records once acceptable packets pass processing by the plurality of algorithms at the security gateway.

5. The security system for the digital asset ledger of claim 1, wherein the security gateway receives packets from a plurality of intermediaries and the format specifies that each packet received from an intermediary should have a field marked with an identification of the intermediary so that a response to the packet can be returned via the intermediary according to the identification.

6. A security method for a digital asset ledger, comprising:
interfacing a security gateway with the public over the internet, the security gateway comprising a memory that stores a plurality of algorithms and a plurality of cores;
executing, by the plurality of cores, the plurality of algorithms in parallel to process packets received over the internet, wherein the packets are required to conform to a format that specifies requirements for fields at predetermined relative locations of payloads of acceptable packets, and each algorithm processes packets by implementing a plurality of safety checks by checking data in the fields at the predetermined relative locations of the payloads of the packets for compliance with the format until the plurality of safety checks are passed or until any safety check is not passed.

7. The security method for the digital asset ledger of claim 6, further comprising:
updating, by the plurality of algorithms, a first specified field at a first predetermined relative location of the payloads of the packets when any safety check is not passed by populating the first specified field with a value corresponding to the safety check that is not passed.

8. The security method for the digital asset ledger of claim 7, further comprising:
storing, at a ledger storage system, records of current ownership of instances of a tracked digital asset, and performing ownership checks by confirming whether ownership listed in each packet that passes processing by the plurality of algorithms at the security gateway is correct for at least one tracked digital asset listed in the packet; and
initiating, by the ledger storage system, disposition of packets according to a second specified field at a second predetermined relative location of the payloads of packets that pass all of the plurality of safety checks at the security gateway and the ownership checks at the ledger storage system,
proactively confirming, by the ledger storage system, ownership of the instances of the tracked digital asset listed in the acceptable packets without transferring ownership of the instances of the tracked digital asset listed in the acceptable packets as a disposition among a plurality of possible dispositions according to a value in the second specified field at the second predetermined relative location.

9. The security method for the digital asset ledger of claim 6, wherein the memory comprises:
addressable memory for storing the packets received from the public, and
sets of registers dedicated to corresponding cores and used for operations when processing the packets; and
wherein the digital asset ledger further comprises:
a main memory system that is physically remote from the security gateway and that is shielded from the public by the security gateway by being inaccessible to the public over the internet at any internet protocol address, that stores historical records of all instances of a tracked digital asset for the digital asset ledger, and that receives updates to the historical records once acceptable packets pass processing by the plurality of algorithms at the security gateway.

10. The security method for the digital asset ledger of claim 6, further comprising:
receiving, by the security gateway, packets from a plurality of intermediaries, wherein the format specifies that each packet received from an intermediary should have a field marked with an identification of the intermediary so that a response to the packet can be returned via the intermediary according to the identification.

11. A security system for a digital asset ledger system, comprising:
a ledger storage system configured to receive packets from a security gateway and comprising:
a ledger storage device configured to store records of current ownership of instances of a tracked digital asset without storing historical records of ownership of the instances of the tracked digital asset; and
a processor configured to perform ownership checks by confirming whether ownership listed in each packet is correct for at least one instance of the tracked digital asset listed in the packet according to a purported owner listed in the packet, and to initiate disposition of packets according to a specified field at a predetermined relative location of payloads of packets that pass all of a plurality of safety checks at the security gateway and the ownership checks at the ledger storage system, wherein the ledger storage system is configured to proactively confirm ownership of the instances of the tracked digital asset listed in acceptable packets without transferring ownership of the instances of the tracked digital asset listed in the acceptable packets as a disposition among a plurality of possible dispositions according to a value in the specified field at the predetermined relative location.

12. The security system of claim 11, wherein the ledger storage device comprises:
dedicated physical memory space for each of a plurality of parties using an intermediary assigned to the security system and party identifications assigned to the parties by the intermediary assigned to the security system.

13. The security system of claim 12, wherein the tracked digital asset comprises a national digital currency and the instances of the tracked digital asset comprise virtual notes of the national digital currency, and wherein the dedicated physical memory space includes predetermined amounts of memory for different denominations of the virtual notes of the national digital currency.

14. The security system of claim 13, further comprising:
the security gateway, wherein the security gateway inspects packets for compliance with a required format before the packets are sent to the ledger storage system, and wherein the digital asset ledger system also includes a main memory that stores historical ownership information of the virtual notes by parties and historical records of ownership of virtual notes for parties.

15. The security system of claim 12, wherein the dedicated physical memory space is increasable in advance for parties that may need more space to store records of current ownership of instances of the tracked digital asset, and wherein the dedicated physical memory space for a party is increasable in real time when a party receives an amount of virtual notes exceeding capacity at the dedicated physical memory space for the party.

16. The security system of claim 11, wherein the processor is further configured to initiate transfer of ownership of virtual notes within the ledger storage system when intermediaries for both parties involved in a transfer are assigned to the ledger storage system, and wherein the processor is further configured to initiate transfer of ownership of virtual notes to a different ledger storage system when an intermediary for a recipient is assigned to the different ledger storage system.

17. The security system of claim 12, wherein the dedicated physical memory space includes a busy or not busy field to counter double spending.

18. The security system of claim 17, wherein the processor is configured to:
check the busy or not busy field in the dedicated physical memory space for a party when performing an ownership check;
queue the ownership check if the dedicated physical memory space for the party is being used; and
set the busy or not busy field to a busy state when using the dedicated physical memory space and to a not busy state when usage is complete.

19. The ledger storage system of claim 11, wherein the processor comprises a graphics processing unit (GPU) configured to perform ownership checks in parallel for different parties.

20. The ledger storage system of claim 11, wherein the ledger storage device comprises a DDR memory, and wherein the ledger storage system comprises a plurality of processors and matched DDR memories to optimize routing and lookups for incoming packets.
